(19) United States
(12) Patent Application Publication
(10) Pub. No.: US 2025/0324987 A1
(43) Pub. Date: Oct. 23, 2025

(54) THERMALLY INHIBITED GRAIN, FLOUR AND STARCH

(71) Applicant: CORN PRODUCTS DEVELOPMENT, INC., Westchester, IL (US)

(72) Inventors: Hongxin JIANG, Bridgewater, NJ (US); Christopher LANE, Bridgewater, NJ (US); Tarak SHAH, Bridgewater, NJ (US)

(21) Appl. No.: 19/258,275

(22) Filed: Jul. 2, 2025

Related U.S. Application Data
(63) Continuation-in-part of application No. 17/983,529, filed on Nov. 9, 2022.
Application No. 17/983,529 is a continuation-in-part of application No. 17/240,923, filed on Apr. 26, 2021, now abandoned.
Application No. 17/240,923 is a continuation of application No. 15/451,081, filed on Mar. 6, 2017, now abandoned.
(63) Continuation-in-part of application No. 18/592,750, filed on Mar. 1, 2024.
Application No. 18/592,750 is a continuation of application No. 17/417,966, filed on Jun. 24, 2021, now abandoned.
(60) Provisional application No. 62/786,066, filed on Dec. 28, 2018.
(60) Provisional application No. 62/846,941, filed on May 13, 2019.

(51) Int. Cl. A21D 6/00; A21D 13/047; A23L 7/10

(52) U.S. Cl. CPC A21D 6/003; A21D 13/047; A23L 7/198

(57) ABSTRACT

A method of thermally inhibiting starch or flour is provided. The method involves thermally or non-thermally dehydrating a grain to anhydrous or substantially anhydrous, and then heat treating this dehydrated grain. The heat treated dehydrated grain is then milled, producing thermally inhibited flour and/or starch. Using this method, the shelf life of the resulting thermally inhibited whole grain flour is extended compared whole grain flours that are thermally inhibited after milling. The foregoing methods applied to starch (following milling of the grain) resulted in starch whiter than obtainable using prior art methods.

Field of the invention: The present invention is directed towards improved thermally inhibited flour and methods of making the same. More specifically, the method dehydrates the whole grain and then heats the grain at sufficient temperature and for sufficient time to produce a thermally inhibited flour when the grain is milled.

Thermally inhibited starch is known, but there is a market for thermally inhibited flour. But the process for making such flours has proved problematic. Flour contains proteins and fats, in addition to the starch. It is known that the fats oxidize over time producing as their major product hexanal, which produces off tastes in flour. Applicants, additionally, discovered that high heat and long heating times necessary to thermally inhibit flour, by itself, oxidizes the lipids. So that thermally inhibited flours have higher hexanal content than non-thermally inhibited flours, even immediately after milling.

Disclosed herein is a method for thermally inhibiting flour having reduce hexanal content, both initially and over time, than thermally inhibited flours of the prior art. In embodiments, the method applies heat-treatment to the whole grain prior to milling. In embodiments, the method comprises dehydrating the grain so that the moisture content of grain is less than about 5% of the total weight of the grain. The dehydration step will occur at a temperature of between about 80° C. and about 100° C. for between about 1 hour and about 24 hours. The grain is then heat treated at a second temperature between about 120° C. to about 180° C. for between about 1 hour and 20 hours. The dehydrated, heat treated grain is then milled to make thermally inhibited whole grain flour. Optionally, in other embodiments, the pH of the whole grain is adjusted prior to dehydration. The pH may be adjusted by steeping the grain in a slightly acidic solution (i.e. pH between about 5 and about 7) at temperature between about 50° C. and about 70° C. for between 1 and 24 hours. The pH adjusted grain is then dried to a moisture content of less than about 12% (w/w) at about 55° C. for between about 1 hour and 12 hours. The dried grain is then dehydrated, heat treated and milled to make thermally inhibited whole grain flour.

Whole grain flour made according to the disclosed method is thermally inhibited and contains less hexanal after zero days storage than flour that is thermally inhibited after milling. In one embodiment the thermally inhibited grain flour contains at least 50% less hexanal than flour thermally inhibited after milling after zero days' storage. In other embodiments flour thermally inhibited grain flour contains at least 60% less hexanal than flour thermally inhibited after milling after zero days' storage. In other embodiments flour made from thermally inhibited grain contains at least 80% less hexanal after milling than flour thermally inhibited after milling after zero days' storage. In other embodiments flour made from thermally inhibited grain contains about 85% less hexanal after milling than flour thermally inhibited after milling after zero days' storage. In embodiments this reduction in hexanal persists so that the thermally inhibit grain flour at 50%, more preferable 60%, more preferable 80%, and most preferably about 85% less hexanal than thermally inhibited flour after 2 or four weeks storage.

Thermally inhibited grain flour made by the claimed method also has improved shelf life compared to non-thermally inhibited flour. In one embodiment thermally inhibited grain flour contains at least about 10% less hexanal after two weeks' storage at room temperature than non-inhibited whole grain flour, preferably at least about 30% less, and more preferably about 40% less. In another embodiment thermally inhibited whole grain flours made by the disclosed methods contains at least about 10% less hexanal after four weeks' storage at room temperature than non-inhibited whole grain flour, preferably at least about 40% less, more preferably at least about 45% less, and more preferably about 50% less.

Also disclosed herein are food products made using the thermally inhibited flour prepared by the disclosed methods.

### BRIEF DESCRIPTION OF THE DRAWINGS

FIG. 1(a) compares the viscosity profile plots of thermally inhibited starches made in some of the various embodiments of the improved method.

FIG. 1(b) plots the end points the of the viscosity profiles plotted in FIG. 1(b).

FIG. 1(c) plots the end points of the viscosity profiles of various thermally inhibited starches and compares the end point plots of thermally inhibited starches obtained using embodiments of the present technology as compared to some embodiments of thermally inhibited starch using prior art technology.

FIG. 2 plots the change in whiteness as thermal inhibition time increases and compares the whiteness for some of the various embodiments thermally inhibited starch made by the improved methods against various embodiments of thermally inhibited starch made by prior common methods.

FIG. 3 plots the viscosity profile, obtained at pH 6 slurry, of thermally inhibited starches obtained by some of the various embodiments of the improved method.

FIG. 4 plots the viscosity profiled, obtained at pH 3, of thermally inhibited starches obtained by some of the various embodiments of the improved method.

FIG. 5 plots the viscosity profile, obtained at pH 3, of thermally inhibited starches obtained by some of the various embodiments of the improved method (which differ from the embodiments of FIG. 4).

Disclosed herein are methods for heat treating a whole grain that, upon milling, yields thermally inhibited grain flour with less hexanal content than flour that is thermally inhibited after milling. This reduction of hexanal persists over time and the thermally inhibited grain flour has less hexanal content than thermally inhibited flour after storage at room temperature for 2 and 4 weeks. The thermally inhibited grain flour also has lower hexanal content than non-thermally inhibited whole grain flour after 0, 2 and 4 weeks after storage.

As used herein thermal inhibition is a process whereby a starch, or flour or cereal grain containing that starch, is heated to a temperature above the starch's gelatinization temperature in a low moisture environment so that the starch does not pregelatinize.

A starch or flour is referred to as inhibited if, when dispersed and/or cooked in water, it exhibits the textural and viscosity properties characteristic of a chemically-cross-linked starch or flour, for example a high degree of stability even in exceptionally harsh conditions. As an exemplary embodiment thermally inhibited flours made according to the disclosed methods exhibit no viscosity break down of solution containing 5% solids after being held at 95° C. and pH 3 for 15 minutes.

As used herein, thermally inhibited starch and thermally inhibited flour mean respectively, a starch or flour that has been thermally inhibited after milling.

As used herein, a thermally inhibited grain is a whole grain that is thermally inhibited prior to milling. The flour made from such grain is thermally inhibited grain flour.

As used herein, a native grain is one as it is found in nature. Suitable native grains for use with the disclosed methods are any cereal grain, including but not limited to, corn, barley, wheat, rice, sorghum, waxy maize, waxy rice, waxy barley, waxy sorghum, cereal grains containing high amylose, and the like.

As used herein a dehydrated grain is a grain that has had its moisture level reduced to be substantially anhydrous or anhydrous.

As used herein a whole grain that has been dehydrated to be substantially anhydrous has a moisture level of less than 5% (w/w).

As used herein a whole grain that has been dehydrated to be anhydrous has a moisture level of less than 2% (w/w).

The disclosed whole grain flours are made according to the various methods disclosed herein. According to one embodiment of the disclosed method, native grains are heat treated by first dehydrating the grain at a first temperature for a time that is sufficient to dehydrate the grain. The grain is then heat treated at a second temperature for a time sufficient that the flour obtained from the grain is thermally inhibited. The thermally inhibited grain is then milled to make thermally inhibited grain flour. In other embodiments of the disclosed methods the pH of the grain is adjusted by steeping the grain in a mildly acidic, buffered solution prior to the dehydration step. Following steeping the grain is dried, and then dehydrated and heat treated to make a thermally inhibited grain. The grain is then milled to make thermally inhibited flour.

Generally the times and temperatures used to thermally inhibit the grain will depend on the desired amount of inhibition of the grain. Following are described specific embodiments and principles for carrying out the invention specifically describing the dehydrating step, the heat treatment step, and the optional steeping step.

In embodiments, the dehydration step reduces the moisture content of the dehydrated grain to less than about 5% (w/w). In other embodiment the grain is dehydrated to less than about 2%. In embodiments where the grain is not pH adjusted prior to dehydration. The dehydration may be done by any method suitable for dehydrating the grain for example by freeze drying, solvent drying, or heat drying.

In embodiments, the grain is dehydrated at temperatures of about 100° C. or less, and more preferably at a temperature or range of temperatures from about 80° C. to about 100° C. The length of time that the dehydration step runs depends on the amount of dehydration desired, and will vary greatly based on the amount of drying desired and the temperature of the step. In embodiments of the disclosed method, the dehydration step can run for up to about 24 hours, but more typically it will run for about between 0.5 hours and 1 hour.

In embodiments the heat treatment step heats the dehydrated grain to thermally inhibit it. The heat treatment step is run at a second temperature for a time sufficient that the flour obtained from the grain is thermally inhibited. The second temperature is higher than the first temperature. In embodiments the second temperature is between 120° C. and 180° C., more preferably between about 130° C. and about 165° C. The heating step will run for various amounts of time depending on the amount of thermal inhibition desired. In embodiments the heating step will run for up to 20 hours. In embodiments of the disclosed method the heating step will run for between about 1.0 hour and 20 hours. More typically not more than 6.0 hours. In other embodiments the heating step is 1, 1.5 or 2.0 hours.

In some embodiments a steeping step is used to adjust the pH of the grain so that it is slightly acidic. The steeping step is run at pH mildly acidic pH, preferably about 5.5 to about 6.5. Conventional acids, such as hydrochloric, sulfuric, phosphoric, carbonic, and acetic acid may be used. The solution is typically buffered to maintain pH during the steeping process. The grain is added to the buffered solution, in a ratio of about 3.0 parts solution to about 1.0 parts grain.

The grain is steeped for between about 1 hour and about 24 hours at a temperature of between about 50° C. and about 70° C. Excess buffer solution is removed, and the grain is dried to a moisture content of about 12% or less at temperature of about 40° C. to about 70° C. over a period of between 1 hour and 12 hours. This drying step is distinct from the dehydration and heat treatment steps. The dried, pH adjusted grain is then dehydrated and heat treated according to the disclosed methods.

In any embodiment described in this specification the grain may be polished before steeping in buffer solution. Polished grain is a commonly understood term in the art, but means at least the removal of hull, bran, and germ from the grain. In at least some embodiments the buffer is a citrate buffer such as potassium citrate or tripotassium citate or sodium citrate. In any embodiment, Citrate buffer is added in an amount less than about 5%, but in an amount more than 0.1% (by weight of the slurry)

The disclosed embodiments use, relative to each other, low temperature for drying, an intermediate temperature for dehydration, and high temperature for heat treatment. Note, however, that although the steps are called drying, dehydration, and heat treatment, and that the steps occur at different temperatures, results of the steps may overlap.

In embodiments the drying, dehydrating, and heat treating steps are part of continuous process. In embodiments the grain is held a first temperature within the range for drying for a period sufficient to dry the grain, then the temperature is ramped to a second temperature within the dehydration range for a period sufficient to dehydrate the grain, and then temperature is ramped to a third temperature within the heat treating range for sufficient time to thermally inhibited the grain. The ramp time will generally be between 5 and 30 minutes. In some embodiments the ramp is done over 15 minutes. In other embodiments the ramp is done over 10 minutes. In other embodiments the drying, dehydrating, and heat treating steps are part of a continuous ramp starting at ambient temperature. In such embodiments the temperature passes through the temperature range for the drying step over a period sufficient to dry the grain, through the dehydrating range over a period of time sufficient to dehydrate the grain. The temperature continues to increase until it reaches a desired end temperature within the range for heat treating the grain. The grain is then subject to heat treatment for sufficient time to thermally-inhibited the grain. Variations on these processes are within the skill in the art and may be used as appropriate.

Useful equipment for dehydration and heat treatment (i.e., thermal inhibition) include any industrial oven (e.g., conventional ovens, microwave ovens, dextrinizers, fluidized bed reactors and driers, mixers and blenders equipped with heating devices, and other types of heaters), provided that the equipment is fitted with a vent to atmosphere or some other dehumidifying mechanism so that moisture does not accumulate and precipitate onto the grain. Preferably, the equipment is modified to remove water vapor from it (e.g., by vacuum or blower for sweeping air from the head-space of the apparatus, by use of a fluidizing gas, or with a dehumidifying device). Heat treatment can be accomplished in the same equipment in which dehydration occurs, and most conveniently is continuous with the dehydrating step. When dehydration is continuous with heat treatment (e.g., when the dehydrating and heat treating apparatus is a fluidized bed reactor or drier), dehydration occurs simultaneously while bringing the equipment up to the final heat treatment temperature.

Once thermal inhibition of the grain is completed, the inhibited grain can then be dry-milled or tempered and wet milled. The flour may be kept as whole grain flour, or the germ components may be removed from the flour according to standard methods. Applying a thermal inhibition process to grains as described in this specification yields various operational advantages compared to a traditional process for thermally inhibiting flour or starch.

Flour is traditionally thermally inhibited by drying milling grain and then applying a thermal inhibition process to the flour. The process darkens the flour (perhaps by a heat induced Maillard reaction). Also, thermally inhibited flours tend to spoil more quickly than untreated flours (perhaps the heating process accelerates fatty acid degradation). It is observed, as described in this specification, that thermally inhibited flour made by applying a thermal inhibition process to a grain has reduced hexanol (a volatile organic molecule associated with rancid odor and taste) than thermally inhibited flour made by applying a thermal inhibition process to the flour.

Starch is traditionally thermally inhibited by wet milling a grain, to separate protein from starch, then applying thermal inhibition process to the starch. Following inhibition the starch is remoistened or washed following the thermal inhibition process, at least to return the thermally inhibited starch to an equilibrium moisture content. In at last some embodiments of a process for making a thermally inhibited starch described in this specification a thermal inhibition process (as described in this specification) is applied to grain, the grain is then wet milled to obtain a thermally inhibited starch. Advantageously the starch is remoistened and washed in the wet milling process eliminating the water use, energy, use and cost associated with washing or remoistening a starch after a thermal inhibition process is applied to the starch.

Additionally, the starch can be removed from the flour according to standard methods. As described herein the flours and starches obtained by treating grains according to the disclosed methods exhibit viscosity profiles similar to flours and starches that are thermally inhibited after milling and or separation. Accordingly, the disclosed methods yield thermally inhibited starch and/or flour. The thermally inhibited grain starches and flours made according to the disclosed methods can then be further modified by enzymes, heat or acid conversion, oxidation, phosphorylation, etherification (particularly, hydroxyalkylation), esterification and/or chemical crosslinking as required for end use application. In embodiments the thermally inhibited grain flour is not further modified.

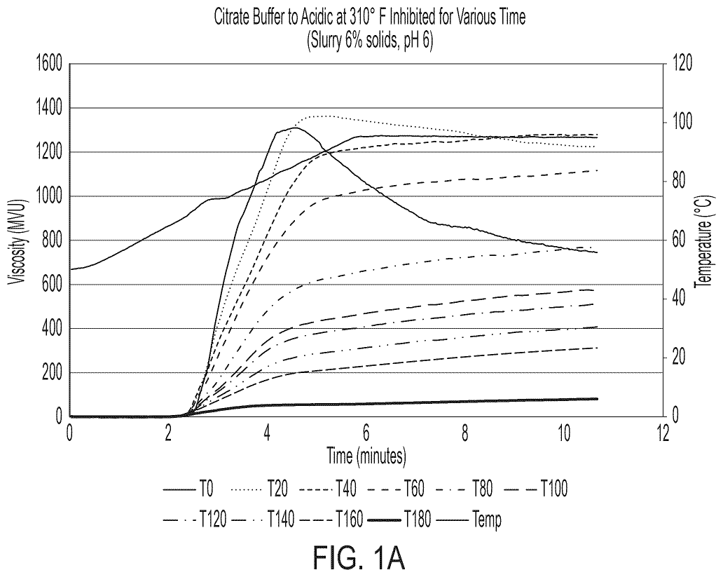

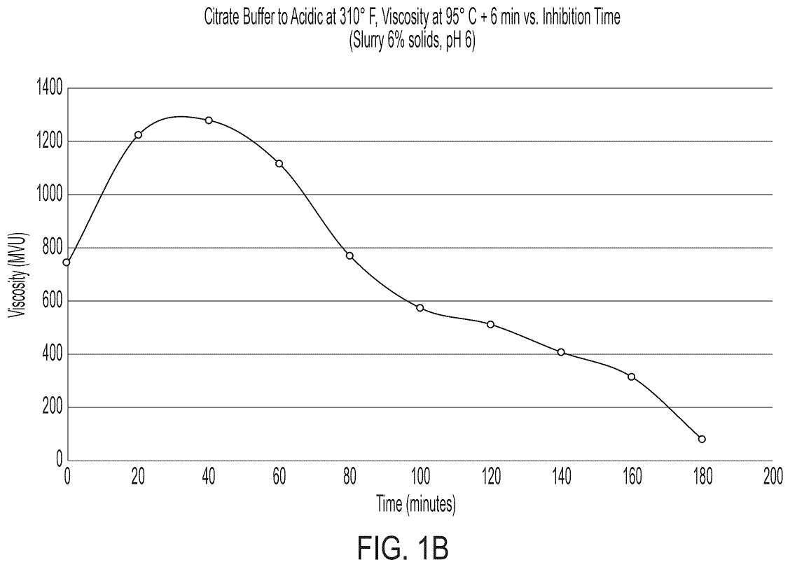

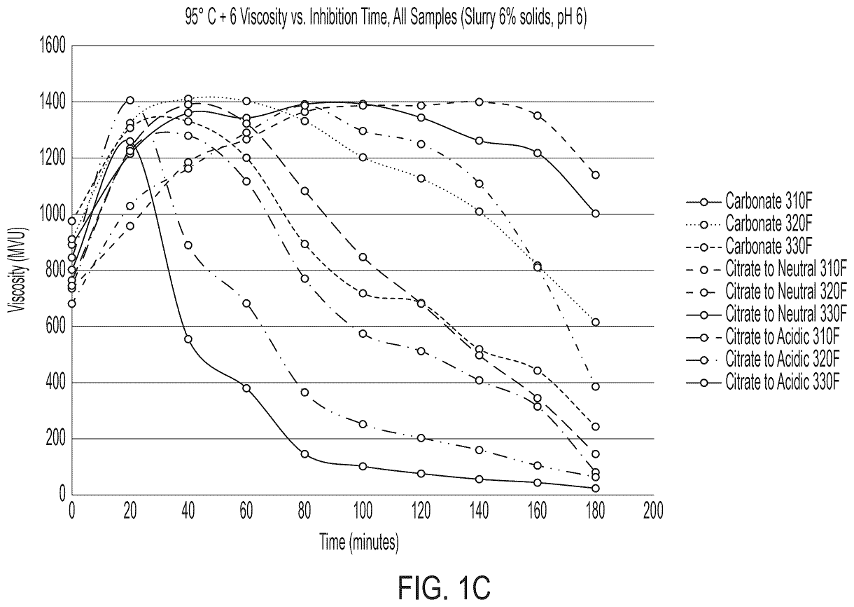

The level of thermal inhibition of the flour made from the disclosed methods can be determined by the viscosity profile of pastes created from the starch. Examples of profiles are provided in FIGS. 1 through 6 which depict various Brabender pasting profiles of starch solutions (5% solids-in-water, 92° C. to 95° C., pH 3 and a paddle speed of 150 RPM).

FIG. 1 compares waxy rice grain flour treated according to the disclosed method (heat treatment to anhydrous grain at 140° C. for 120 minutes) and flour from non-inhibited waxy rice flour. As seen the non-inhibited waxy rice flour has a higher peak viscosity, and lower ending viscosity than the flour from the thermally inhibited grain, which has no peak viscosity. This indicates a thermally inhibited grain because of 1) the lower viscosity compared to the peak viscosity of the non-inhibited grain suggests that the granules of the thermally inhibited grain flour resisted expansion during heating in solution, and 2) the higher viscosity compared to the end viscosity of the non-inhibited flour suggest that the granules of the thermally inhibited grain flour resisted breaking down during extended heating.

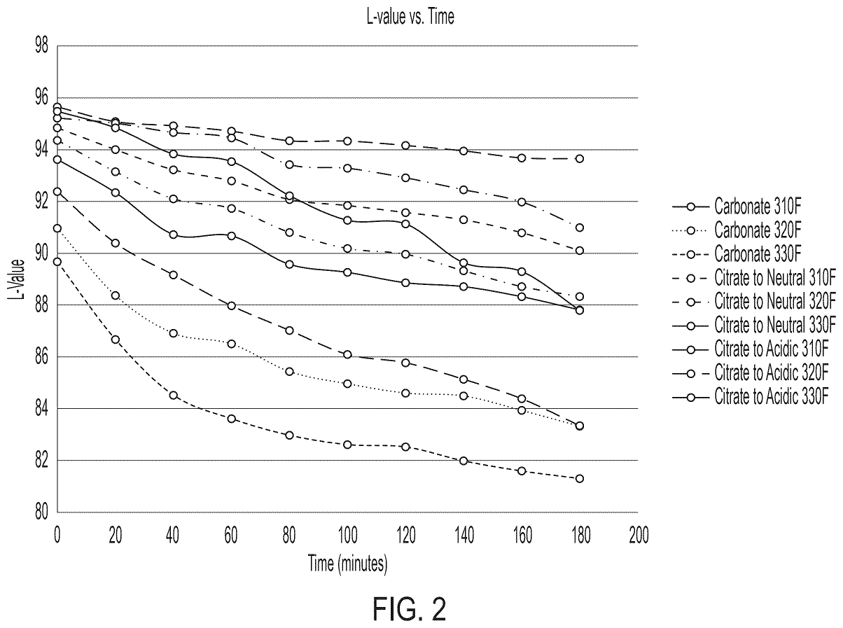

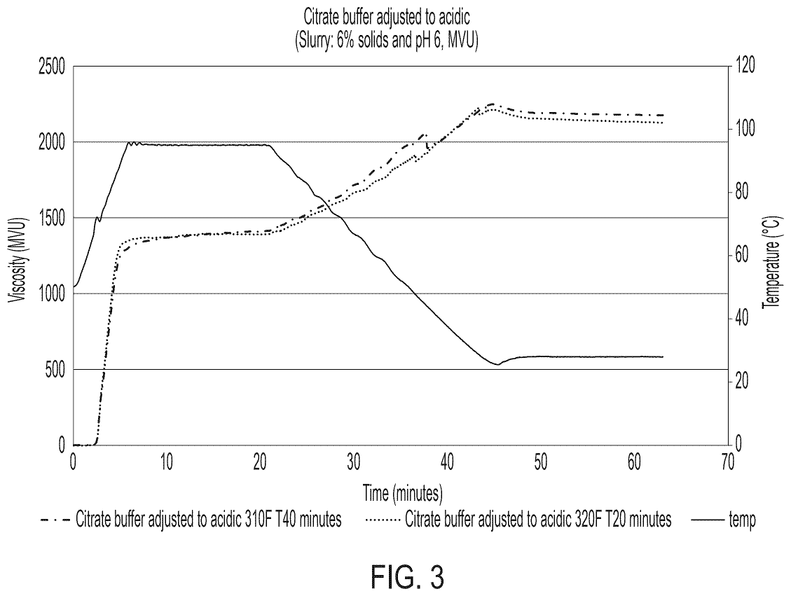

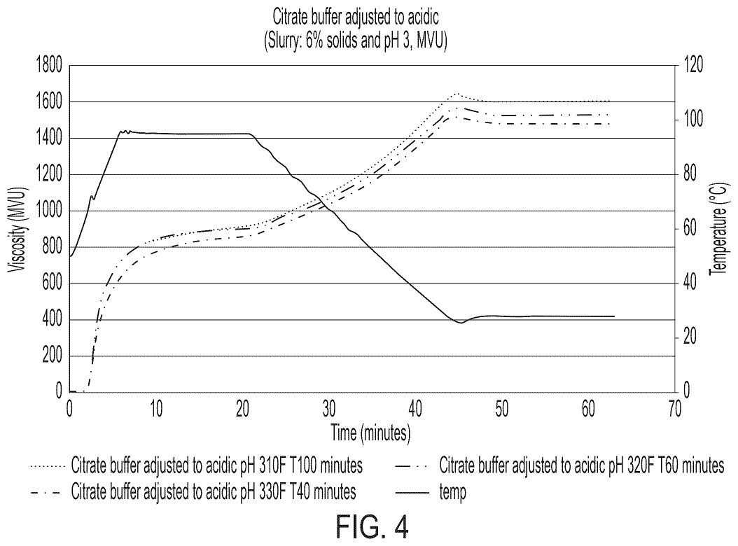

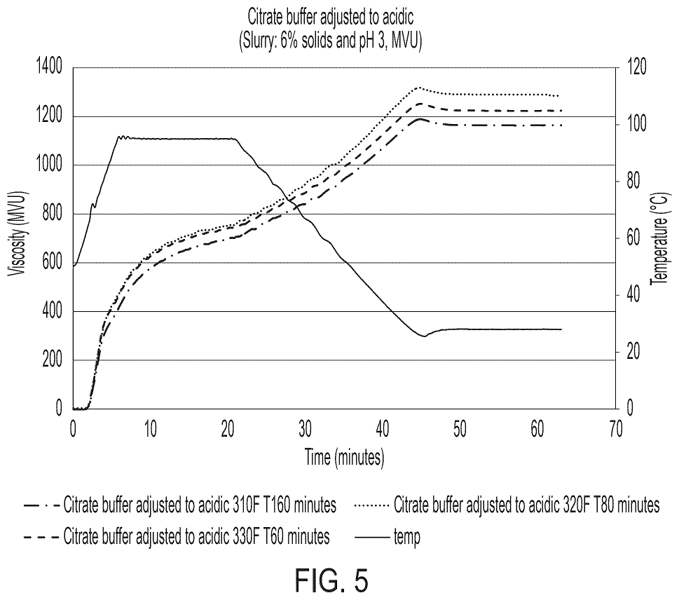

FIGS. 2 and 3 provide the viscosity profiles of thermally inhibited grain flour (i.e. milled after thermal inhibition) made from waxy rice and waxy corn. As shown, although generally being heat treated for longer time, the thermally inhibited grain flour has viscosity profiles that mimicked thermally inhibited flour (i.e. milled before thermal inhibiting) made from waxy rice and waxy corn. Similarly, as shown in FIGS. 4 and 5, the pH adjusted thermally inhibited grain flour exhibits viscosity profiles similar to pH adjusted thermally inhibited flour.

In embodiments, the thermally inhibited grain flour has less hexanal than to non-inhibited whole grain flour after 0, 2, and 4 weeks storage. Hexanal is a product of fatty acid oxidation, it gives flour an off taste, in other words it indicates the level of oxidative rancidity in flour. Hexanal levels can be measured by headspace gas chromatograph coupled with flame ionization detection (FID). In one embodiment thermally inhibited whole grain flour made by the disclosed methods contain at least about 10% less hexanal after two weeks' storage at room temperature than non-inhibited whole grain flour, preferably at least about 30% less, and more preferably about 40% less. In another embodiment thermally inhibited whole grain flours made by the disclosed methods contain at least about 10% less hexanal after four weeks' storage at room temperature than non-inhibited whole grain flour, preferably at least about 40% less, more preferably at least about 45% less, and more preferably about 50% less. In other embodiments of the invention, waxy corn flour made according to the disclosed methods has hexanal values of less than about 1.8 ppm after between two and four weeks storage, preferably less than about 1.0 ppm and, more preferably less than about 0.9 ppm. In other embodiments of the invention, waxy rice flour made according to the disclosed methods has hexanal values of less than about 3.0 ppm after between two and four weeks storage, preferably less than about 2.0 ppm, and more preferably less than about 1.5 ppm.

In embodiments, the thermally inhibited grain flour contains less hexanal after zero days storage than flour that is thermally inhibited after milling. In one embodiment the thermally inhibited grain flour contains at least 50% less hexanal than flour thermally inhibited after milling after zero days' storage. In other embodiments flour thermally inhibited grain flour contains at least 60% less hexanal than flour thermally inhibited after milling after zero days' storage. In other embodiments flour made from thermally inhibited grain contains at least 80% less hexanal after milling than flour thermally inhibited after milling after zero days' storage. In other embodiments flour made from thermally inhibited grain contains about 85% less hexanal after milling than flour thermally inhibited after milling after zero days' storage. In embodiments this reduction in hexanal persists so that the thermally inhibit grain flour at 50%, more preferable 60%, more preferable 80%, and most preferably about 85% less hexanal than thermally inhibited flour after 2 or 4 weeks storage.

The flours and starches made according to the disclosed methods, whether or not further modified may be used in food products in the same way as other flours and starches, for example in baked goods, as food coatings, as thickeners and the like. The amount of flour used is in accordance with needs of the use.

The source of the grain, dehydrating conditions, heating time and temperature, initial pH, and whether or not moisture is present during the process steps are all variables that affect the degree of inhibition that can be obtained. All these factors are interrelated and an examination of the Examples will show the effect that these different variables have on controlling the degree of inhibition, as well as the textural and viscosity characteristics of the inhibited products. The following examples are provided as illustrations and should not be construed to limit the scope of the invention in any way. Persons of ordinary skill in the art will recognize that routine modifications may be made to the methods and materials used in the examples, which would still fall within the spirit and scope of the present invention.

Through modification of the procedures described above so that the pH adjustment to acidic conditions is done to starch and not grain and so that starch is buffered and soaked so that it reaches a stable pH between 4.5 and 5.5 prior art thermally inhibited starches can be improved so that they are inhibited to a high degree of thermal inhibition faster and are whiter in color than prior art starches. This and further aspects of using an acidic pH adjustment are described below.

In any embodiment, thermally inhibited starches can be made from one or more of the following base materials corn, waxy corn, high amylose corn, tapioca, waxy tapioca, potato, waxy potato, rice, waxy rice, sago, arrowroot, legume (seeds from plants of the family leguminosae, including peas, chick peas, lentils, fava beans, lupin bean, and mung bean), sorghum, barley, waxy barley, and wheat. Within in this specification reference to waxy corn starch includes reference to hybrids, crossbreeds, and other waxy corn starch variants, including but not limited to a hybrid waxy corn starch sold by Ingredion Incorporated under the name WaxiPro® corn starch. Within this specification, waxy, as a descriptor of a starch, means a starch having low amylose, such as less than about 10% or, or less about 7%, or less that about 5%, or less than about 3%, or less than about 1% or essentially 0% amylose content by weight. Within in this specification high amylose as a description of a starch means a starch having great than about 40% amylose, for example by not limited to starch having about 50% amylose content by weight or starch having about 70% weight amylose in a starch granule.

The present technology pertains to thermally inhibited starch and to dry thermally inhabited starch. In some embodiments a dry thermally inhibited starch has a whiteness as described by a Hunter L that is equal to the whiteness of a native starch from the same base. In various other embodiments a dry thermally inhibited starch has a Hunter L value of greater than about 92, or greater than 93, or greater than 94, or greater than 95, or about 92 to about 96 or about 92 to about 95, or about 93 to about 95, or about 94 to about 95, or about 95. In any embodiment of the thermally inhibited starch, the forgoing whiteness is obtained regardless of the level of inhibition. In various embodiments the foregoing whiteness is obtained regardless of washing, starch may be washed using known techniques to further improve the whiteness of the obtained starch

In some embodiments a thermally inhibited starch or a dry thermally inhibited starch has a whiteness as described by a Hunter L value of 92, or greater than 92, or greater than 93, or greater than 94, or greater than 95, or about 92 to about 96 or about 92 to about 95, or about 93 to about 95, or about 94 to about 95, or about 95 and has improved flavor such as reduced grainy flavor, cardboard flavor, plastic flavor, vinyl flavor or mixtures thereof. In any embodiment of the thermally inhibited starch, the foregoing whiteness and improved flavor is obtained regardless of the level of inhibition.

In some embodiments a thermally inhibited, or dry thermally inhibited starch is thermally inhibited to have a desired hot peak viscosity. In any embodiments a hot peak viscosity can be measured using a Micro-Visco-AmyloGraph (MVAG) (available for example from Brabender GmbH & Co KG), which plots the relative viscosity changes in a starch slurry over a defined time and temperature course. In any embodiment a thermally inhibited starch can be measured in Micro-Visco-AmyloGraph Units (“MVAG-Units,” “MVU”). Commonly MVAG plots measure the viscosity change of starch slurry as temperature ramps from relatively cool to a peak hot temperature at which the starch slurry is held for a defined time. A commonly used MVAG plot records the viscosity changes of a 6% starch solids slurry having pH 6 during the following time and temperature course: heating of starch slurry from room temperature to 50° C., further heating of slurry from 50° C. to 95° C. at a heating rate of 8° C./min and holding slurry at 95° C. for 15 minutes (also called in this specification 95° C.+15). Extended MVAG testing may further plot the viscosity change of the slurry as it cools after heating is completed at 95° C.+15. A useful viscosity measurement is the peak hot viscosity, which is the highest viscosity obtained between 95° C. and 95° C.+15. In embodiments a starch is inhibited to have a peak hot viscosity of up to about 2000 MVU, or about 50 and about 2000 MVU, or less than about 500 MVU, or about 50 to about 500, or about 100 to about 500 MVU, or about 100 to about 400 MVU, or about 100 to about 300 MVU, or about 100 to about 200 MVU, or about 500 to about 1200 MVU, or about 600 to about 1200 MVU, or about 700 to about 1200 MVU, or about 800 to about 1200 MVU, or about 900 to about 1200 MVU, or about 1000 to about 1200 MVU, or about 1200 to about 2000 MVU, or about 1300 to about 2000 MVU, or about 1400 to about 2000 MVU, or about 1500 to about 2000 MVU, or about 1600 to about 2000 MVU, or about 1700 to about 2000 MVU, or about 1800 to about 2000 MVU.

In some embodiments a thermally inhibited starch or dry thermally inhibited starch has a high level of inhibition, which can be described as a thermally inhibited starch having a peak hot viscosity (slurry at 6% solids and pH 6) of less than about 600 MVU, or less than about 500 MVU or less than about 400 MVU, or about 100 to less than about 600 MVU, or about 200 to less than about 600 MVU, or about 300 to less than about 600 MVU, or about 200 to about 500 MVU, or about 300 to 500 MVU. In some embodiments a highly thermally inhibited starch has a peak hot viscosity (slurry at 6% solids and pH 6) of about 200 to less than about 600 MVU. In some embodiments a highly thermally inhibited starch has a peak hot viscosity (slurry at 6% solids and pH 6) of about 300 to about 500 MVU. In some embodiments a thermally inhibited a highly thermally inhibited starch further has a rising viscosity (slurry at 6% solids and pH 3) from 95° C. to 95° C.+15 minutes. In some embodiments a thermally inhibited a highly thermally inhibited starch further has a viscosity (slurry at 6% solids and pH 3) from 95° C. to 95° C.+15 of about 500 to about 1000 MVU, or about 500 to about 900 MVU, or about 500 to about 800 MVU, or about 500 to about 700 MVU, or about 600 to about 1000 MVU, or about 700 to about 1000 MVU, or about 600 to about 900 MVU, or about 600 to about 800 MVU, or about 700 to about 800. In some embodiments a thermally inhibited a highly thermally inhibited starch further has a viscosity (slurry at 6% solids and pH 3) from 95° C. to 95° C.+15 of about 600 to 900 MVU. In some embodiments a highly thermally inhibited starch further has a viscosity (slurry at 6% solids and pH 3) from 95° C. to 95° C.+15 of about 700 to 800 MVU. In any embodiments thermally inhibited starch having a high level of inhibition further has a whiteness (as measured by Hunter L value) of greater than about 91, or greater than 92, or greater than 93, or greater than 94, or greater than 95, or about 91 and about 96 or about 92 to about 95. In any embodiments, thermally inhibited starch having a high level of inhibition further has a whiteness (as measured by Hunter L value) of about 91 to about 94. In any embodiments thermally inhibited starch having a high level of inhibition further has a whiteness (as measured by Hunter L value) of about 94. In any embodiments a starch having highly thermal inhibition further has improved flavor such as reduced grainy flavor, cardboard flavor, plastic flavor, vinyl flavor or mixtures thereof.

In any embodiments a thermally inhibited starch or dry thermally inhibited starch has a moderate level of inhibition, which can be described as a thermally inhibited starch having a peak hot viscosity (slurry at 6% solids and pH 6) of about 600 to about 1100 MVU, or about 600 to 1000 MVU, or about 600 to about 900 MVU, or about 600 to 800 MVU. In any embodiments a thermally inhibited starch having a moderate level of inhibition has a peak hot viscosity (slurry at 6% solids and pH 6) of about 600 to about 1000 MVU. In some embodiments a thermally inhibited starch having a moderate level of inhibition has a peak hot viscosity (slurry at 6% solids and pH 6) of about 600 to about 800 MVU. In some embodiments a thermally inhibited starch having a moderate level of inhibition further has a steady viscosity (slurry at 6% solids and pH 3) from 95° C. to 95° C.+15 minutes or a viscosity that varies less than about 200 MVU, or less than about 150 MVU, or less than about 100 MVU, or less than about 50 MVU. In any a thermally inhibited starch having a moderate level of inhibition further has a whiteness of greater than about 92, or greater than 92, or greater than 93, or greater than 94, or greater than 95, or about 92 to about 96 or about 92 to about 95. In any embodiments, thermally inhibited starch having a moderate level of inhibition further has a whiteness (as measured by Hunter L value) of about 93 to about 95. In any embodiments, thermally inhibited starch having a moderate level of inhibition further has a whiteness (as measured by Hunter L value) of about 94. In any embodiments, thermally inhibited starch having a moderate level of inhibition further has a whiteness (as measured by Hunter L value) of about 95. In any embodiments a starch having moderately thermal inhibition further has improved flavor such as reduced grainy flavor, cardboard flavor, plastic flavor, vinyl flavor or mixtures thereof.

In any embodiments, a thermally inhibited starch or dry thermally inhibited starch has a low level of inhibition which can be described as a thermally inhibited starch having a peak hot viscosity (slurry at 6% solids and pH 6) of about 1200 to about 2000 MVU, or about 1200 to about 1900 MVU, or about 1200 to about 1800 MVU, or about 1200 to about 1700 MVU, or about 1200 to about 1600 MVU, or about 1200 to about 1500, MVU or about 1300 to about 1600 MVU, or about 1300 to about 1500 MVU in a continuous process. In any embodiments a thermally inhibited starch having a low level of inhibition has a peak hot viscosity (slurry at 6% solids and pH 6) of about 1200 to about 1700 MVU. In any embodiments a thermally inhibited starch having a low level of inhibition has a peak hot viscosity (slurry at 6% solids and pH 6) about 1300 to about 1500 MVU. In any embodiments a thermally inhibited starch in slurry (6% solids and pH 6) having low inhibition, further has a steady viscosity from 95° to 95°+15 minutes or has a viscosity that varies less than about 200 MVU, or less than about 150 MVU, or less than about 100 MVU, or less than about 50 MVU. In any embodiments a starch having low thermal inhibition further has a whiteness (as measured by Hunter L value) of greater than about 92, or greater than 92, or greater than 93, or greater than 94, or greater than 95, or about 92 and about 96 or about 92 and about 95. In any embodiments a starch having low thermal inhibition further has a whiteness (as measured by Hunter L value) of about 94 to about 96. In any embodiments a starch having low thermal inhibition further has a whiteness (as measured by Hunter L value) of about 95. In any embodiments a starch having low thermal inhibition further has improved flavor such as reduced grainy flavor, cardboard flavor, plastic flavor, vinyl flavor or mixtures thereof.

Relative viscosity of a starch slurry over a defined time and temperature course may also be measured using a rapid-visco-analyzer (RVA), which reports viscosity in cP. RVA tests may use the same time and temperature course as used for MVAG testing. Like MVAG, it is useful to know the peak hot viscosity of a starch slurry during an RVA test. Peak hot viscosity has the same meaning in RVA testing as it does in MVAG testing—i.e. obtained between 95° C. and 95° C.+15. MVU.

Useful peak viscosities as measured by cP are generally within the same ranges as for MVU. Accordingly, in embodiments, a starch is inhibited to have a peak hot viscosity of up to about 2000 cP, or about 50 and about 2000 cP. Similarly highly inhibited starches have peak hot viscosity of less than about 500 cP, or about 50 to about 500 cP, or about 100 to about 500 cP, or about 100 to about 400 cP, or about 100 to about 300 cP, or about 100 to about 200 cP. Moderately inhibited starches have a peak hot viscosity of about 500 to about 1200 cP, or about 600 to about 1200 cP, or about 700 to about 1200 cP, or about 800 to about 1200 cP, or about 900 to about 1200 cP, or about 1000 to about 1200 cP. Starches having low inhibition have peak hot viscosity of about 1200 to about 2000 cP, or about 1300 to about 2000 cP, or about 1400 to about 2000 cP, or about 1500 to about 2000 cP, or about 1600 to about 2000 cP, or about 1700 to about 2000 cP, or about 1800 to about 2000 cP.

In some embodiment a thermally inhibited starch or dry thermally inhibited starch may have a swelling volume, which may also be referred to as a sediment volume (i.e. volume of the starch sediment after being allowed to fully swell), or a swelling power. Generally highly inhibited starch swells less than lesser inhibited starches. Swelling volume varies greatly based on measurement conditions, including how much starch is used in the testing solution, as salt prevents starch swelling. Swelling volumes for highly, moderately and lowly inhibited starches range from about 1 to about 50 mg/L and all subranges within. Swelling volume may be measured as follows: a) preparing a 5% starch slurry in 1% NaCl solution in a beaker; b) heating the slurry in the beaker using a boiling water bath having a minimum temperature of 95° C. for 20 minutes, stirring for the first 3 minutes and then cover with a watch glass for the remaining time; c) diluting the slurry to 1% and allowing to settle for 24 hours and optionally and measuring the volume of the settled starch.

In other non-limiting embodiments specification discloses methods for making a thermally inhibited starch or a dry thermally inhibited starch. In any embodiment described in this specification, a method for thermally inhibiting a starch may be thought of as including a starch preparation step and a thermal inhibition step. In any embodiment a starch preparation step includes an optional neutralization step, a buffering step and a pH adjusted step. In any embodiment described in this specification, a thermal inhibition step includes a dehydration step and a thermal inhibition step.

In any embodiment starch preparation step is carried out in one or more starch slurries, where slurry is used as it is commonly used in the art. Without limiting the full understanding of the term, a slurry may be understood to be a semiliquid mixture, comprising liquid and fine particles. Starch slurries useful in this invention do not have lower solids content limit. At an upper bound, the starch content is high enough that the mixture is no longer semiliquid; in this state the composition may be referred as a starch cake—i.e. wet starch that sticks together and is able to form a cohesive mass. In any embodiment a starch slurry comprises about 30% to about 60% starch by weight of the slurry, or about 35% to about 55%, or about 35% to about 50% or about 35% to about 45%, or about 36% to about 44% or about 37% to about 43% or about 40%. In any embodiment starch slurries useful for making thermally inhibited starch have solids content between 35% to 50% starch solids. In any embodiment a slurry useful for making a thermally inhibited starch is an aqueous slurry.

In any embodiment, a method for making a thermally inhibited starch as described in this specification comprises, prior to thermal inhibition, soaking a starch in a buffered solution or an aqueous buffered solution to form a buffered starch. In any embodiment the forgoing buffering step uses a suitable food grade buffer. In any embodiment described in this specification, a food grade buffer useful for making a thermally inhibited starch is a conjugate acid, or salt of an organic acid. In at least some embodiments the buffer is a carbonate buffer or a citrate buffer. In some embodiments a food grade buffer is potassium citrate and/or tripotassium citrate. In any embodiment a food grade buffer is added to a starch slurry prior to thermal inhibition in an amount less than less than about 10% by weight of the starch or less than 5%, or less than about 4% or less than about 3% or less than about 2% or less than about 1% or between greater than 0% to about 4% or about 0.1% to about 3% or about 0.1% to about 2% or about 0.1% to about 1% or about 0.5% to about 2% or about 0.6% to about 2% or about 0.8% to about 2% or about 0.9% to about 2% % or about 1% to about 2% or about 1% or the starch.

In any embodiment using a citrate buffer in the pH adjustment step the total citrate content of the slurry is less than about 5% by weight of the starch, or less than about 4% or less than about 3% or less than about 2% or less than about 1% or between greater than 0% to about 4% or about 0.1% to about 3% or about 0.1% to about 2% or about 0.1% to about 1% or about 0.5% to about 2% or about 0.6% to about 2% or about 0.8% to about 2% or about 0.9% to about 2% % or about 1% to about 2% or about 1% or the starch. In some embodiments a method of making a thermally inhibiting starch or dry thermally inhibited starch comprises adjusting the pH of a starch by adding a buffer (e.g. a citrate buffer) in an amount about 0.1% and about 2% (w/w of starch) to a starch slurry. In some embodiments a method of making a thermally inhibiting starch or dry thermally inhibited starch comprises adjusting the pH of a starch by adding a buffer (e.g. a citrate buffer) in an amount about 0.5% and about 1.5% (w/w of starch) to a starch slurry. In some embodiment a method of making a thermally inhibiting starch or dry thermally inhibited starch comprises adjusting the pH of a starch by adding a buffer (e.g. a citrate buffer) in an amount of about 0.9% and about 1.2% (w/w of starch) to a starch slurry. In any embodiment a starch is soaked in a buffered solution for at least about 0.25 hours or about 0.25 to about 24 hours, or from about 0.3 hours to about 12 hours or from about 0.5 to about 8 hours. It is observed that the pH of the slurry increases over time during soaking such that after soaking a starch in buffer solution for from 0.5 to 24 hours, the starch slurry's pH is from about 6.5 to about 7.5.

It is observed that starch commonly has a natural pH of about 5.0 to about 6.5, but that commonly the processes used to separate starch from protein alter the starch's natural pH. In any embodiment described in this specification, prior to buffering, a starch may be obtained having a pH other than a natural pH of from about 5.0 to about 6.5. In any embodiment of the processes described in this specification, a starch is obtained having a pH less than about 5.0 and adjusting the pH of the starch by soaking the starch in a solution including a suitable base (including but not limited to sodium hydroxide) to obtain a starch having a pH of from about 5.0 to about 6.5. In any embodiment of the processes described in this specification, a starch is obtained having a pH greater than about 6.5 and adjusting the pH of the starch by soaking the starch in a solution including a suitable acid (including but not limited to hydrochloric acid) to a starch having a pH of from about 5.0 to about 6.5. In any embodiment described in this specification, a starch is soaked in acidic or basic solution until a starch slurry has a stable pH of from 5.0 to 6.5. In any embodiment described in this specification, a starch is soaked in acidic or basic solution for at least about 0.25 hours or for about 0.25 to about 24 hours, or from about 0.3 hours to about 12 hours or from about 0.5 to about 8 hours

In any embodiment described in this specification, a method for making a thermally inhibited starch comprises adjusting the pH of a buffered starch slurry to an acidic pH prior to thermal inhibition. In any embodiment a buffered starch is adjusted to a native pH and is soaked in a buffered solution for at least about 0.25 hours or 0.25 to about 24 hours, or from about 0.3 hours to about 12 hours or from about 0.5 to about 8 hours. In any embodiment a starch is pH adjusted to an acidic pH for enough time for the pH of the starch slurry to stabilize at a pH of from greater than 4.0 to less than 6.0, or to more than about 4 to about 5.5 or to more than about 4 to about 5.4, or to more than about 4 to about 5.3, or to more than about 4 to about 5.2, or to more than about 4 to about 5.1 or to more than about 4 to about 5, or to more than about 4 to about 4.9, or to more than about 4 to about 4.8, or to more than about 4 to about 4.7 or to more than about 4 to about 4.6, or to more than about 4 to about 4.5, or about 4.1 to about 4.6, or about 4.2 to about 4.7, or about 4.3 to about 4.8, or about 4.5 to about 5.5, or about 4.4 to about 5.5, or about 4.3 to about 5.5, or about 4.2 to about 5.5 or about 4.1 to about 5.5, or about 4.6 to about 5.4, or about 4.8 to about 5.3. In any embodiment adjusting the pH of the slurry may including adjusting the pH to about 4.5 and 5.5. In any embodiment the adjusting the pH slurry may include adjusting the pH to about 4.8 to about 5.2. In any embodiment the adjusting the pH may include adjusting the pH to about 5 or at least about 5. In any embodiment a starch's pH is measured by, after dewatering and drying the starch from solution, resuspending the dry starch in water in a water to starch ratio of 4:1 and measuring the pH.

In any embodiment disclosed in this specification amount pH of the acidic starch slurry is controlled to limit or prevent the starch hydrolysis, as measured by soluble content. In any embodiment disclosed in this specification a thermally inhibited starch has soluble content of less than about 20%, or less about 15%, or less than about 10%, or less than about 5% or essentially 0%.

In any embodiment adjusting the pH of a starch comprises adding a food grade acid to a starch or a starch slurry. In any embodiment a food grade acid is any food grade or organic or mineral acid. In some embodiments a food grade acid used to adjust the pH of a starch or starch slurry include hydrochloric acid, sulfuric acid. In some embodiments a food grade acid is hydrochloric acid.

In any embodiment a method for making a thermally inhibited starch comprises, prior to thermal inhibition, dehydrating a starch to desired moisture content (w/w/) to obtain a starch having a desired low moisture content. In various embodiments the recovered, pH is adjusted starch is dehydrated to a moisture content of less than about 5% or less than about 4%, or less than about 3% or less than about 2% or less than about 1% or about 0% moisture content by weight of the starch, or to about 0% to about 6% or to about 0% to about 3%, or about 0% to about 2%, or to about 1% to about 5%, or to about 1% to about 4%, or to about 1% and about 3%, or to about 1% to 2% or to about 1%, or to about 0%. In some embodiments a pH adjusted starch is dried to moisture content of about 4% to about 6%, or to about 5% moisture content by weight of the starch, which is sometimes called to a substantially anhydrous state. In some embodiments a pH adjusted starch is dried to moisture content of about 0% to about 2%, or to about 1% moisture content by weight of the starch, which is sometimes called to an anhydrous state. In any embodiment a starch is dehydrated using conventional dry techniques such as flash drying, or oven drying, or freeze drying, or spray drying, or drying in a reactor suitable for thermally inhibiting a starch such as a fluidized bed rector. In any embodiment a method of making a dry thermally inhibited starch comprises drying a starch or a pH adjusted starch at a temperature sufficient to dry the starch but below the starch's gelatinization temperature. In any embodiment a method of making a thermally inhibited starch comprises drying a starch at a temperature below about 120° C., or below about 110° C. or below about 105° C., or below about 100° C. or about 80° C. to about 120° C., or about 85° C. to about 120° C., or between about 90° C. to about 110° C., or about 95° C. to about 110° C., or about 95° C. to about 105° C.

In any embodiment a method for making a thermally inhibited starch comprises dry heating a pH adjusted, dehydrated starch to one or more temperatures exceeding the starch's gelatinization temperature. In some embodiments the method comprises dry heating a dehydrated starch to a temperature above about 120° C., or above about 130° C., or above about 135° C., or above about 140° C., or above about 145° C., or above about 150° C., or above about 155° C., or above about 160° C., or above about 165° C., or up to a temperature of about 180° C., or about 120° C. to about 200° C., or about 120° C. to about 190° C., or about 120° C. to about 180° C., or about 130° C. to about 170° C., or about 135° C. to about 165° C., or about 140° C. to about 165° C., or about 145° C. to about 165° C., or about 150° C. to about 165° C., or about 155° C. to about 165° C. In any embodiment a starch is heated to a temperature about 155° C. to about 165° C. In any embodiment a starch is heated to a temperature of about 165° C. In any embodiment a starch is heated to a temperature of about 160° C. In any embodiment a starch is heated to a temperature of about 155° C.

In various embodiments a method for making a thermally inhibited starch comprises dry heating a pH adjusted, dehydrated starch for less than about 0.5 hours, or about 0.05 to about 4 hours, or about 0.1 to about 4 hours, or about 0.2 to about 4 hours, or about 0.2 to about 3 hours, or to about 0.2 to about 2 hours, or about 0.2 to about 1.5 hours, or about 0.25 to about 1.5 hours, or about 0.3 to about 1.5 hours, or about 0.35 to about 1.5 hours, or about 0.4 to about 1.5 hours, or about 0.45 to about 1.5 hours, or about 0.5 to about 1.5 hours, or about 0.5 to about 1 hour, or about 0.5 to about 0.9 hours, or about 0.5 to about 0.8 hours, or about 0.5 to about 0.7 hours, or about 0.5 to about 0.6 hours, about 0.1 hours, or about 0.2 hours, or about 0.3 hours, or about 0.4 hours or about 0.5 hours, or about 0.6 hours, or about 0.7 hours, or about 0.8 hours, or about 0.9 hours, or about 1 hour. In any embodiment a starch may thermally inhibited dry heating a pH adjusted, dehydrated starch for about 20 minutes (0.33 hours) and about 200 minutes (3.33 hours). In any embodiment a starch may thermally inhibited dry heating a pH adjusted, dehydrated starch for about 20 minutes (0.33 hours) and about 60 minutes (1 hour). In any embodiment a starch may thermally inhibited dry heating a pH adjusted, dehydrated starch for about 20 minutes (0.33 hours) and about 40 minutes (0.67 hours). In any embodiment a starch may thermally inhibited dry heating a pH adjusted, dehydrated starch for about 1 hour and 2 hours.

Reference to dry heating mean heating in air or other gas that does not chemically react with starch under the above described heating conditions. Dry heating is contrasted with heating in alcohol or other non-aqueous solution. Air used for dry heating may have various moisture content, but in any embodiment the moisture content of the air is less than needed to gelatinize the starch. In any embodiment starch is dehydrated in air at air pressure of about 1 atmosphere. In any embodiment starch is thermally inhibited in air at air pressure of about 1 atmosphere.

In some embodiments, the dehydrating and the thermally inhibiting may occur in the same apparatus. In some embodiments the dehydrating and the thermally inhibiting steps may occur in separate or different apparatuses.

In any embodiment, during thermally inhibiting, the starch (i.e. the pH adjusted starch and/or the pH adjusting and dehydrated starch) may be substantially free of alcohol. As used herein, “substantially free, means less than about 2 wt % alcohol, including less than about 1% wt or less than 0.5% wt, based on the weight of the starch. In any embodiment, during thermally inhibiting the starch may comprise no alcohol. In any embodiment, during dehydration the starch may comprise no alcohol. Alcohol means free of C4 alcohols and below, including but not limited to methanol, ethanol, propyl, or iso propyl alcohol.

In any embodiment a starch may be washed in water or aqueous solution prior to a starch slurry or after thermally inhibiting for one or more cycles.

The present technology provides a method including adding a buffer and an acid to a starch to obtain a pH adjusted starch having an acidic pH, dehydrating the pH adjusted starch to obtain a dehydrated, pH adjusted starch, and thermally inhibiting the dehydrated pH adjusted starch. During the pH adjustment step the buffer and acid may be added in either order.

The present technology provides a method including adjusting a starch in slurry to have a natural pH, adding buffer to the starch slurry, adjusting the pH of the slurry to an acidic pH, dehydrating the starch and thermally inhibiting the starch.

In some embodiments the technology provides a method including mixing starch, buffer, acid and aqueous solution to obtain a starch slurry and to obtain pH adjusted starch, recovering the pH adjusted starch from the starch slurry, dehydrating the pH adjusted starch to obtain a pH adjusted, dehydrated starch, and thermally inhibiting the pH adjusted, dehydrated starch. In any embodiment the buffer, acid, and aqueous solution may be mixed with the starch in any order. In any embodiment the aqueous solution may be water, or may be a buffered solution, or may be an acidic solution. In any embodiment a starch is adjusted at temperature below the starch's gelatinization temperature. In any embodiment a starch is thermally inhibited at temperature above the starch's gelatinization temperature.

The present technology further provides a starch made by the foregoing method. The present technology further provides starch made by the foregoing method and having a Hunter L value of than about 92, or greater than 92, or greater than 93, or greater than 94, or greater than 95, or about 92 to about 96 or about 92 to about 95, or about 93 to about 95, or about 94 to about 95, or about 95. The technology further provides starch made by the foregoing method having the forgoing hunter L values and having improved flavor compared to starches made from prior art processes.

In some embodiments, thermally inhibited starch having a low level of thermally inhibited is made at a temperature of about 150° C. to about 170° C. for about 25 to 150 minutes, or about 50 to 150 minutes or about 100 to 150 minutes.

In some embodiments thermally inhibited starch having a moderate level of inhibition has is made at a temperature of about 150° C. to 180° C. for about 30 to 100 minutes. In some embodiments thermally inhibited starch having a moderate level of inhibition has is made at a temperature of about 150° C. to 170° C. for about 60 to 100 minutes. In some embodiments thermally inhibited starch having a moderate level of inhibition has is made at a temperature of about 160° C. to 180° C. for about 30 to 50 minutes.

In some embodiments a highly thermally inhibited is made at a temperature of about 155° C. to 180° C. for about 30 to 200 minutes. In some embodiments a highly thermally inhibited is made at a temperature of about 160° C. to 170° C. for about 30 to 60 minutes. In some embodiments a highly thermally inhibited is made at a temperature of about 160° C. to 170° C. for about 100 to 200 minutes. In some embodiments a highly thermally inhibited is made at a temperature of about 160° C. to 170° C. for about 150 to 200 minutes.

The above described methods for making a thermally inhibited starch physically modify the starch to act like a chemically modified starch. Using the methods described herein yields thermally inhibited starches that behave like chemically crosslinked starches without being chemically crosslinked. Using the methods described herein yields thermally inhibited starches that are not acid hydrolyzed.

The present technology provides methods for making thermally inhibited starches in a batch reaction process, a continuous reaction process or the like, or a combination thereof.

In some batch reaction processes a fixed amount of starch may be held in a reactor for enough time to thermally inhibited starch to obtain a desired peak hot viscosity after which the starch may be released from the reactor. Some illustrative batch reaction processes may use a fluidized bed reactor. Fluidized bed reactors may include a shell reactor and may have one or more chambers that allow a fluid to flow through a solid; in any embodiment the fluid is air. The fluid may disperse the solid (and in any embodiment a starch) to form a relatively homogenous fluid-solid system. The shell reactor may be jacketed to provide heat. An illustrative fluid bed reactor is described in U.S. Pat. No. 5,378,434, which is incorporated herein in its entirety. Solids may be held in the reactor shell for an indefinite time and can be emptied from through an orifice in the reactor shell following completion of the reaction. Such reactions may utilize fixed amount that may be loaded into a reactor shell, may then be thermally inhibited, and then may be removed from the reactor shell before a next fixed amount of starch may be added to the reactor shell. In some embodiments a method for making thermally inhibited starch comprises heating a fixed amount of pH adjusted starch at one or more temperatures to dehydrate the starch and to thermally inhibited the starch, wherein such heating may be continuous or stepped. In some other embodiments a method for making a thermally inhibited starch includes heating a fixed amount of dehydrated, pH adjusted starch at one or more temperatures to thermally inhibited the starch.

Other reactors useful for thermally inhibiting starch include dextrinizers and the like, in which a starch is fluidized using mechanical means, such as rotational means, such as mixers having blades, paddles, rotors, screws, etc. that in operation cause the starch to move in a fluid like manner. Such reactors may be jacketed with heaters or steam heated to maintain the desired temperature for thermally inhibiting starch. In some embodiments thermally inhibiting using a mechanical fluidizing means is done under substantially vacuum conditions.

In some continuous reaction process a starch may added to and may pass through a reactor in time continuous manner such that starch is held in the reactor for a fixed time before it leaves, or is forced out of, or is otherwise removed from the reactor. In some embodiments the temperature used to obtain a thermally inhibit starch is adjusted to account for the residence time of the starch within the reactor. In some embodiments a starch is held in a reactor is modified to hold a starch for enough time to obtain a desired degree of inhibition. In some embodiments a process may include a fluidized bed that has been modified to allow for a substantially continuous process. In some embodiments a modified fluidized useful for making a thermally inhibited starch in a substantially continuous process is disclosed in U.S. Pat. No. 7,722,722, which is incorporated herein by reference. In some embodiments an apparatus for use includes a reactor shell having one or more sections connected in series by an aperture permitting solid material to pass from one cell to the next in a time sequential fashion. The reactor shell may further include one or more cells at least one of which may be jacketed to allow for heating the starch sample. In some embodiments starch continuously passes from one cell to next and eventually exits the reactor shell after being held in residence within the reactor for a time to thermally inhibit a starch to have a desired hot peak viscosity. In some embodiments a method for making thermally inhibited starch includes passing a pH adjusted starch through a continuous reactor at one or more temperatures to dehydrate the starch and to thermally inhibited the starch wherein progress from one temperature to another may be continuous or stepwise. In some other embodiments a method for making a thermally inhibited starch includes passing an amount of a dehydrated, pH adjusted starch through a continuous reactor at one or more temperatures to thermally inhibited the starch.

In some other embodiments of a continuous reaction process use a reactor such as those available from Vomm Impianti e Processi Srl and described in EP 0 710 670, which is incorporated herein by reference. In some embodiments such reactors may include a heated tubular reactor and may impel starch through a horizontal length of the reactor using a rotor blade. Other methods used in industry to dry or thermally modify solid materials may also be used.

In some embodiments starch is thermally inhibited to a low level of inhibition in a continuous process at a temperature of about 150° C. to about 170° C. at about 10 to about 40 minutes. In some embodiments starch is thermally inhibited to a low level of inhibition in a continuous process at a or about 150° C. to about 160° C. for about 25 to about 40 minutes. In some embodiments starch is thermally inhibited to a low level of inhibition in a continuous process at about 160° C. to 170° C. for about 10 to about 25 minutes, or from about 10 to about 15 minutes. In some embodiments, thermally inhibited starch having a moderate level of inhibition is made in a continuous process in a continuous process at about 150° C. to about 170° C. for about 60 to about 100 minutes, or about 60 to about 70 minutes. In some embodiments, thermally inhibited starch having a moderate level of inhibition is made in a continuous process at a temperature of about 160° C. to about 180° C. for about 10 to about 25 minutes. In some embodiments a highly thermally inhibited is made in a continuous process at a temperature of about 180° C. and about 200° C. for between about 10 and about 25 minutes. In each of the foregoing embodiments, the starch has whiteness as measured by Hunter L value of at least about 91 or at least about 92 or from about 91 to about 95 or from about 92 to about 95.

The present technology provides thermally inhibited starches having higher processes tolerance than prior art starches.

The present technology provides uses of thermally inhibited starch in industrial products, cosmetic products, household products, pharmaceutical product, and edible products, and combinations thereof. In some embodiments a thermally inhibited starch is used as an ingredient in a food composition.

In some embodiments thermally inhibited starches are used in a food composition in amount of between 1% and 99% by weight product. In some embodiments a thermally inhibited starch is an ingredient in an edible composition, which may be provided for nutritive, non-nutritive, pharmaceutical, or nutraceutical purposes. In some embodiments an edible product is in tablet form, and a thermally inhibited starch is used as an excipient or binding agent, or disintegrating agent.

In some embodiments an edible product comprises a thermally inhibited starch and a second edible ingredient. In any embodiment a second edible ingredient is any edible second ingredient. In some embodiments a second edible a dairy ingredient including milk (and other liquid milk products), non-fat milk solids, or dairy proteins such as whey or casein. In some embodiments a second edible ingredient is an aqueous ingredient having a pH between 3 and 8, such ingredients include but are not limited milk, fruit and vegetable juices (from any source), vinegar, oils, and liquid extracts. In some embodiments a second edible ingredient is another starch or flour which may be in native, pregelatinized, or other modified form. In some embodiments a second ingredient is a gum or hydrocolloid. In some embodiments a second ingredient is useful as a stabilizers or emulsifier in food. In some embodiments a second ingredient is eggs or a saponin comprising extract or flour. In some embodiments a second ingredient is a fermenting agent or leavening agent such as yeast, or bacteria, or baking soda, or baking powder.

In some embodiments a thermally inhibited starch is an ingredient in a food composition which may be one or more the following non-limiting example: beverages, baked goods (cakes, cookies, brownies, pie crusts, bread, gluten-free product), confectionary products, retorted products, frozen products, dairy products, sauces, gravies, emulsions. In some embodiments a thermally inhibited starch is used in amount of about 1 to about 99% by weight of the food composition of about 1 to about 50% by weight, like for example about 1 to about 10%. In some embodiments, a baked good includes about 25% to about 50% by weight of a thermally inhibited starch, or about 25 to about 35%. In some embodiments in a baked good a thermally inhibited starch makes up about 25% to 100% of all starch in the baked good, or about 50 to 100%, or about 75 to 100%. In some embodiments a food composition includes a liquid component for example a aqueous component or an oil component such composition including for example beverages, retorted products, sauces, gravies, yogurts and other dairy compositions, or emulsified compositions like mayonnaises, in such compositions a thermally inhibited starch is used in amounts of about 0.1 to 20% or about 1% to about 15% or about 1% to about 10% or about 1% to about 5.

In some embodiments a thermally inhibited starch is used to provide stable thickness to an emulsion or emulsion like food product including but not limited to food products processed and/or stored under harsh conditions, such as retorting, homogenization, fermenting, and freezing. In various embodiments a dry thermally inhibited starch is used to provide free-thaw stability, or to resist syneresis, or retrogradation of frozen edible products.

In some embodiments a thermally inhibited starch is used in an edible product to replace a chemically crosslinked, or otherwise inhibited starch. In some embodiments a thermally inhibited starch is to replace a non-inhibited starch. In some embodiments a thermally inhibited starch is used to reduce the amount of starch used in an edible composition.

Throughout this specification various ranges are listed which are intended to include all subranges within the disclosed ranges, and any pairing of the specifically named ranges.

Non-limiting embodiments of food compositions comprising a thermally inhibited starch follow:

### Illustrative Recipes

1a. Yogurt:

TABLE 1a
Yogurt Recipe

| Ingredients | Wt. % |
|---|---|
| Non-fat milk | 95.01 |
| Nonfat dry milk low heat | 1.34 |
| Gelatin | 0.3 |
| Starch | 3.35 |
| Total | 100.0% |

All the dry ingredients are blended together and added to the milk. The mixture is blended using a Breddo Likwifier blender for 20-30 minutes at about 500 rpm, transferred to a holding tank, and then processed through MicroThermics® HVHW HTST processing equipment wherein, for upstream processing, the mixture is homogenized at 60° C. (140° F.) and 725 or 2175 psi, and then pasteurized at 98° C. (208° F.) for 6 minutes. For downstream processing, the mixture was preheated to 65° C. (150° F.), and then heated at 85-90° C. (185-195° F.) and 725 or 2175 psi for 6 minutes. The pasteurized yogurt mix was cooled to about 43° C. (110° F.). In samples that are fermented, the pH was reduced to 4.6 and the yogurt cooled to about 7-13° C. (45-55° F.). In other embodiments, homogenization is run at 65° C. In embodiments the homogenization process includes a pre heat, and in embodiments temperature and pressure are ramped from ambient to those desired from pasteurization.

1b. Mayonnaise

TABLE 1b
Mayonnaise Recipe

| | |
|---|---|
| Water | 55.35 |
| Vinegar (10%) | 4.5 |
| Mustard (medium spicy) | 2.5 |
| Egg yolk (pasteurized) | 3.5 |
| Rape seed oil | 25.0 |
| Sugar | 3.0 |
| Salt | 1.0 |
| Potassium sorbate | 0.15 |
| Starch | 5.0 |
| Total | 100.0% |

All the dry ingredients are blended together and added to the water. The mixture is blended under vacuum (600-700 mbar) using a Fryma Korum DISHO 7 inline homogenizer. The water phase is then heated to 95° C. to cook the starch, and then cooled to 30° C. or below. The egg yolk is added and blended with the water phase. The oil is then added to the pre-emulsion under high shear and vacuum (600-700 mbar) and homogenized until emulsified. The vinegar is then added and emulsified, and the temperature kept at about 20° C.

1c. Spoonable Dressing—

TABLE 1c
part 1
Formulation Part 1-Spoonable Dressing

| Ingredients (%) | Wt. % |
|---|---|
| Water | 61.0 |
| Vinegar (120 grain) | 12.50 |
| Sugar | 17.70 |
| Mustard powder | 1.10 |
| Paprika | 0.10 |
| Salt | 2.60 |
| Starch¹ | 5.00 |
| Total | 100.0% |

All the dry ingredients are blended together and added to the water and vinegar under agitation for complete dispersion. The mixture is heated to 195° C. to 200° C. for about 15 to 20 minutes to a good degree of starch cook. The resultant paste is then cooled to 80° C. The following ingredients are then added together—

TABLE 1c
part 2
Formulation Part 2-Spoonable Dressing

| Ingredient | Wt. % |
|---|---|
| Paste | 65.00 |
| Egg yolks | 4.50 |
| Vegetable oil | 30.50 |
| Total: | 100.00 |

The egg yolks are added to the paste and mixed well. The oil is then slowly added with agitation to form a pre-emulsion. This pre-emulsion is then passed through a colloid mill to form the final spoonable dressing emulsion.

1d. Cream Soup—

TABLE 1d
Cream Soup recipe

| Ingredients | Wt. % |
|---|---|
| Water | 68.9 |
| Cream | 15.0 |
| Mushrooms ¹ | 10.0 |
| Sugar | 0.71 |
| Salt | 0.7 |
| Onion Powder | 0.25 |
| Lecithin (8.7% on fat) | 0.5 |
| White Pepper | 0.04 |
| Starch ² | 3.9 |
| Total | 100.0% |

All dry ingredients are blended together. The water and cream are added to a beaker and the lecithin dispersed using an immersion blender. The dry ingredients are then added under agitation. The mixture was heated to 88° C. to 90° C. (190° F. to 195° F.) and held until a good starch cook is reached (about 12 to 18 minutes). Once cooled, each mixture was then used to fill 2-ounce jars. Powdered mixes can be made by substituting dry ingredients such as powdered milk solids for cream.

1e. Béchamel

TABLE 1e
Béchamel Recipe

| Ingredient | (wt) % |
|---|---|
| Whole Milk | 91.28 |
| Unsalted Butter | 5.00 |
| White Pepper | 0.02 |
| Salt | 0.30 |
| Starch | 3.00 |
| Soy Lecithin | 0.40 |
| Total | 100.00 |

1f. Pudding

TABLE 1f
Pudding Recipe

| Ingredients | % |
|---|---|
| Milk 2% | 84.55 |
| Sugar | 10.00 |
| Starch | 5.25 |
| Vanilla Flavor | 0.20 |
| Total | 100.00 |

Pudding are made by whisking the starch, sugar, and vanilla into milk and mixing until the ingredients are dispersed. The mixture is then cooked in a Thermomix® with set temperature to 90° C. During cooking the mixture is stirred at speed 1 for 40 minutes or until starch is fully cooked out. The cooked pudding is then filled into jars and allowed to cool.

In industrial scale processes, all the dry ingredients are blended together and added to the milk. The mixture is blended using a Breddo Likwifier blender for 20-30 minutes at about 500 rpm, transferred to a holding tank, and then processed through MicroThermics® HVHW HTST processing equipment wherein, for upstream processing, the mixture is homogenized at 60° C.-65° C. (140-150° F.) and 725-2175 psi, and then pasteurized at 98° C. (208° F.) for 30 seconds. The cooked pudding is then filled into jars and allowed to cool.

The following are further illustrative embodiments of the thermally inhibited starch as well as characterization of that starch.

1g. Gravy

TABLE 1g
Gravy Recipe

| Ingredients | % |
|---|---|
| Milk 2% | 92.00 |
| Starch | 4.00 |
| Flavor (e.g. chicken or beef) | 1.00 |
| Salt | 2.00 |
| Color | 1.00 |
| Total | 100.00 |

1h. Pet Food

TABLE 1h(i)
Pet Food Recipe 1

| | Chicken Dices | Gravy |
|---|---|---|
| Ingredient | Weight % | Weight % |
| Water | 1 | 90 |
| Pork Liver | 40 | 0 |
| Chicken Parts | 16 | 0 |
| Whole Chicken | 16 | 0 |
| Beef Lungs | 12 | 0 |
| Soybean Flour, Defatted | 6 | 0 |
| Sugar | 0 | 5 |
| Powdered Blood Plasma | 5 | 0 |
| Modified Waxy Cassava Starch¹ | 0 | 4 |
| Animal Fat | 1 | 0 |
| Salt (NaCl) | 1 | 0.5 |
| Dicalcium Phosphate | 1 | 0 |
| Caramel Color (Liquid) | 0 | 0.5 |
| Color, Vitamins, Minerals and Antioxidant | 1 | 0 |
| Total | 100 | 100 |

TABLE 1h(ii)
Pet Food Recipe 2

| | Beef Slices | Gravy |
|---|---|---|
| Ingredient | Weight % | Weight % |
| Water | 1 | 90 |
| Beef | 40 | 0 |
| Beef Lungs | 20 | 0 |
| Pork Liver | 20 | 0 |
| Beef Spleen | 13 | 0 |
| Soybean Flour, Defatted | 7 | 0 |
| Sugar | 0 | 5 |
| Powdered Blood Plasma | 4.5 | 0 |
| Modified Waxy Cassava Starch¹ | 0 | 4 |
| Animal Fat | 2 | 0 |
| Salt (NaCl) | 1 | 0.5 |
| Dicalcium Phosphate | 1 | 0 |
| Color | 0 | 0.5 |
| Vitamins, Minerals and Antioxidant | 0.5 | 0.5 |
| Total | 100 | 100 |

The following aspects nineteen are illustrative and are not intended to limit the full scope of the technology as applied to unmilled grains.

1. A method of preparing thermally inhibited grain flour comprising: dehydrating the grain to anhydrous or substantially anhydrous at a first temperature; heat treating the dehydrated grain at a second temperature that is higher than the first temperature for a period of time sufficient to obtain, after milling, a thermally inhibited grain flour; milling the heat treated, dehydrated grain to obtain a thermally inhibited grain flour.

2. The method of claim 1 wherein the grain is steeped in acidic solution prior to the dehydrating step to adjust the pH of the grain.

3. The method according to claim 2, wherein the pH is adjusted to between about pH 5.5 and about pH 6.5.

4. The method according to claim 2, wherein the grain is dried after steeping at a third temperature that is lower than said first and second temperatures.

5. The method according to claim 1, wherein the grain is dehydrated to anhydrous.

6. The method according to claim 1, wherein the thermal dehydration step is carried out by heating the grain at a temperature of between about 80° C. and about 100° C.

7. The method according to claim 1 wherein the heat treating is carried out at a temperature of about 120° C. to about 180° C. from about 1 hour to about 20 hours.

8. The method according to claim 1 wherein the heat treating is carried out at a temperature of about 130° C. to about 165° C. from about 1 hour to about 20 hours.

9. A method of preparing thermally inhibited grain flour comprising: steeping a whole grain in a buffered solution having a pH between about 5.5 and about 6.5; drying the grain at a first temperature of between about 30° C. and about 70° C. dehydrating the grain to anhydrous or substantially anhydrous at a second temperature of between about 80° C. and 100° C.; heat treating the dehydrated grain at a third temperature of about 130° C. to about 165° C. from about 1 hour to about 20 hours; milling the heat treated, dehydrated grain to obtain a thermally inhibited grain flour.

10. A thermally inhibited grain flour prepared by the process of: dehydrating a grain to anhydrous or substantially anhydrous; heat treating the dehydrated grain at a temperature and for a time sufficient so that, after milling a thermally inhibited flour is obtained; milling the heat treated dehydrated grain to produce thermally inhibited flour; The thermally inhibited grain flour of claim 10 wherein the processes further comprises the step of steeping the grain in buffered solution to adjust the pH of the grain prior to the dehydration step.

11. The thermally inhibited grain flour of claim 10 wherein the thermally inhibited grain flour has less hexanal after zero days storage than a flour thermally inhibited after milling.

12. The thermally inhibited grain flour of claim 10 wherein the thermally inhibited grain flour has at least 50% less hexanal after 0 days storage than a flour thermally inhibited after milling.

13. The thermally inhibited grain flour of claim 10 wherein the thermally inhibited grain flour has about 85% less hexanal after 0 days storage than a flour thermally inhibited after milling.

14. The thermally inhibited grain flour of claim 13 wherein the thermally inhibited grain flour has at least 50% less hexanal after 2 weeks storage at room temperature than a flour thermally inhibited after milling.

15. The thermally inhibited grain flour of claim 13 wherein the thermally inhibited grain flour has at least 50% less hexanal after 4 weeks storage at room temperature than a flour thermally inhibited after milling.

16. The thermally inhibited grain flour of claim 10 wherein the thermally inhibited flour produces between about 10% and 50% less hexanal after storage for four weeks at room temperature.

17. A food product comprising the thermally inhibited flour of claim 10.

18. A thermally inhibited grain flour characterized by having at least 50% less hexanal after o days storage than a flour thermally inhibited after milling.

19. The thermally inhibited grain flour of claim 18 further characterized by having at least 50% less hexanal after 4 week storage as room temperature than a flour thermally inhibited after milling.

The following aspects are illustrative and not intended to limit the technology as applied to starch and low protein compositins.

1. An improved thermally inhibited starch.

2. The thermally inhibited starch of claim 1 having a Hunter L value of greater than about 92, or of about 92 to about 96.

3. The thermally inhibited starch of claim lor 2 having a hot peak viscosity (slurry at 6% solids, and pH 6) of about 50 to about 2000 MVU, or of about 50 to than about 500 MVU, or of about 500 to about 1200 MVU, or of about 1200 of about 2000 MVU.

4. The thermally inhibited starch of any one of claims 1 to 3 having a hot peak viscosity (slurry at 6% solids, and pH 6) of about 50 to about 2000 cP, or of about 50 to about 500 cP, or of about 500 to about 1200 cP, or of about 1200 to about 2000 cP.

5. The thermally inhibited starch of any one of claims 1 to 4 having a hot peak viscosity (slurry at 6% solids and pH 6) of about 50 to about 500 MVU and a Hunter L value of at least about 91, or from about 91 to about 94.

6. The thermally inhibited starch of any one of claims 1 to 5 further having a viscosity (slurry at 6% solids and pH 3) from 95° C. to 95° C.+15 of about 500 to about 1000 MVU.

7. The thermally inhibited starch of any one of claims 1 to 6 having a hot peak viscosity (slurry at 6% solids, and pH 6) of about 500 to about 1200 MVU and having a Hunter L value of about 93 to about 95.

8. The thermally inhibited starch of any one of claims 1 to 7 further having a viscosity (slurry at 6% solids and pH 3) that varies less than about 200 MVU at from 95° C. to 95° C.+15 minutes.

9. The thermally inhibited starch of any one of claims 1 to 8 having a hot peak viscosity (slurry at 6% solids, and pH 6) of about 1200 to about 2000 MVU and having a Hunter L value of about 94 to about 96.

10. The thermally inhibited starch of any one of claims 1 to 9 further having a viscosity (slurry at 6% solids and pH 6) that varies less than about 200 MVU at from 95° C. to 95° C.+15 minutes.

11. The thermally inhibited starch of any one of claims 1 to 10 having a sedimentation volume of about 10 to about 50 mL/g.

12. The thermally inhibited starch of any of claims 1 to 11 being obtained by thermally inhibiting a milled plant material to obtain a thermally inhibited milled plant material, the thermally inhibited starch being present in the thermally inhibited milled plant material.

13. The thermally inhibited starch of any of claims 1 to 12 being obtained by thermally inhibiting a milled and fractionated plant material to obtain a thermally inhibited and fractionated plant material, the thermally inhibited starch being present in the thermally inhibited milled and fractionated plant material.

14. The thermally inhibited starch of any one of the claims 1 to 13 wherein prior to thermal inhibition the milled and fractionated plant material has a starch content greater than 95% (w/w).

15. The thermally inhibited starch of any of claims 1 to 14 being obtained from food grade starch.

16. The thermally inhibited starch of any of claims 1 to 15 having been obtained from the group consisting of corn, waxy corn, high amylose corn, tapioca, waxy tapioca, potato, waxy potato, rice, waxy rice, sago, pea, chick pea, lentil, and fava bean.

17. The thermally inhibited starch of any one of claims 1 through 16 being substantially free of alcohol.

18. The thermally inhibited starch of any one of claims 1 through 17 being a thermally inhibited and dehydrated in a dry process.

19. The thermally inhibited starch of any one of claims 1 to 18 made by a process comprising: i) adding buffer and acid to a starch to obtain a pH adjusted starch having an acidic pH; ii) dehydrating the pH adjusted in a dry process to obtain a dehydrated, pH adjusted starch; iii) and thermally inhibiting the dehydrated, pH adjusted starch in a dry process.

20. The thermally inhibited starch made by the process of claim 19 wherein the buffer is and in amount of less than about 5% by weight of the starch.

21. The thermally inhibited starch made by the process of claim 19 or 20 wherein the buffer is a citrate buffer.

22. The thermally inhibited starch made by the process of any one of claims 19 to 21 wherein during step i) the starch's pH is adjusted to about 4 to less than about 6, or to about 4.5 to about 5.5.

23. The thermally inhibited starch made by the process of any one of claims 19 to 22 wherein the pH adjustment to the starch in step i) occurs in an aqueous starch slurry, wherein the starch slurry comprises the starch, the buffer and the acid; wherein the starch slurry has a pH of about 4 to less than about 6 or of about 4.5 to about 5.5.

24. The thermally inhibited starch made by the process of any one of claims 19 to 23 wherein during step iii) the dehydrated, pH adjusted starch is substantially free of alcohol.

25. The thermally inhibited starch made by the process of any one of claims 19 to 24 wherein during step ii) the pH adjusted starch is substantially free of alcohol.

26. Use of the thermally inhibited starch as recited in any preceding claim in an industrial product, cosmetic products, household product, and edible product.

27. An edible composition comprising the thermally inhibited starch as recited in any one of claim 1 through 25 and a second edible ingredient.

28. The edible composition of claim 27 being selected from the group consisting of pharmaceutical composition, nutraceutical composition, non-nutritive composition, or food composition.

28. The edible composition of claim 27 being a food composition

29. The edible composition of claim 27 being a food composition being selected from the group consisting of a sauce, a gravy, a dressing, a dairy product, a yogurt, a baked good, a retort product, and a soup.

30. The edible composition of claim 27 being selected from the groups consisting of a sauce, a gravy, a dressing, a dairy product, a yogurt, a retort product, and a soup, wherein the starch is used in amount of about 1% to about 10% by weight of the composition.

31. The edible composition of claim 27 being a baked good wherein the baked good has a total starch content of about 25% to about 50% starch of the baked good, and wherein the thermally inhibited starch makes up between about 25% and about 100% of the total starch (by weight of the total starch).

32. A method for making a thermally inhibited starch comprising: providing a starch and i) adding buffer and acid to the starch to obtain a pH adjusted starch having an acidic pH; and ii) thermally inhibiting the pH adjusted starch.

33. The method of claim 32 wherein the pH adjusted starch has pH of about 4 to less than about 6.

34. The method of claim 32 or 33 wherein the buffer is added in an amount less than 5% of the starch.

35. The method of any one of claims 32 to 34 wherein the buffer is a citrate buffer.

36. The method of any one of claims 32 to 35 wherein the pH adjustment in step i) occurs in an aqueous slurry; the aqueous slurry including the acid, the buffer, and the starch the aqueous slurry thereby having acidic pH.

37. The method of any one of claims 32 to 36 wherein the pH adjustment in step i) occurs in an aqueous slurry having a pH of about 4 to less than about 6.

38. The method of any one of claims 32 to 37 wherein the pH adjusted starch is thermally inhibited in step ii) by heating the starch to a temperature above the starch's gelatinization temperature for a time of about 0.05 to about 4 hours, or about 0.33 to about 3.33 hours, or between about 1 and about 2 hours.

39. The method of any one of claims 32 to 38 wherein the pH adjusted starch is thermally inhibited in step ii) by heating the pH adjusted starch at a temperature of about 120° C. to about 200° C.

40. The method of any one of claims 32 to 39 wherein prior to step ii) the pH adjusted starch is dehydrated to a moisture content below about 5% by weight of the starch.

41. The method of any one of claims 32 to 40 wherein prior to step ii) the pH adjusted starch is dehydrated at a temperature below the starch's gelatinization temperature.

42. The method of any one of claims 32 through 41 wherein the pH adjusted starch is thermally inhibited in step ii) for about 0.05 to about 1.5 hours.

43. The method of any one of claims 32 to 42 wherein the pH adjusted starch is thermally inhibited in step ii) a temperature of about 150° C. to about 170° C. for about 20 to about 40 minutes.

44. The method of any one of claims 32 to 43 wherein the pH adjusted starch is thermally inhibited in step ii) at a temperature of 160° C. to 180° C. for about 30 to about 50 minutes

45. The method of any one of claims 32 to 44 wherein the pH adjusted starch is thermally inhibited in step ii) at a temperature of 160° C. to 180° C. for about 45 and about 60 minutes.

46. The method of any one of claims 32 to 45 wherein the pH adjusted starch is dehydrated and thermally inhibited in a dry process.

47. The method of any one of claims 32 to 46 wherein the pH adjusted starch is dehydrated and thermally inhibited in air or vacuum.

48. The method of any one of claims 32 to 47 wherein the starch is provided as a milled plant material or a milled and fractionated plant material.

49. The method of any one of claims 32 to 48 wherein the starch is provided as a milled and fractionated plant material having a starch content of greater than about 95% starch by weight.

50. The method of any one of claims 32 to 49 wherein the starch is provided as a food grade starch.

51. The method of any one of claims 32 to 50 wherein during the thermal inhibition of step ii) the pH adjusted starch is substantially alcohol free.

52. The method of any one of claims 32 to 51 wherein prior to the thermal inhibition of step ii) the pH adjusted starch is dehydrated and during dehydration the pH adjusted starch is substantially alcohol free.

53. The method of any one of claims 32 to 52 making a substantially alcohol free thermally inhibited starch.

54. The method of any one of claims 32 to 49 further comprising washing the starch prior to step i) or after step ii) or both.

55. The method of any one of claims 32 to 54 wherein the method is carried out in one of a batch process, a continuous-like process, a continuous process and combinations thereof.

56. The method of any one of claims 32 to 55 wherein the pH adjusted starch is thermally inhibited in a fluid bed reactor.

57. The method of any one of claims 32 to 56 wherein the pH adjusted starch is thermally inhibited in a continuous process, and optionally wherein the continuous process runs for about 10 to about 25 minutes.

58. The method of any of claims 32 to 57 wherein the pH adjusted starch is thermally inhibited in a VOMM reactor.

59. The method of any one of claims 32 to 58 wherein the starch is dehydrated and thermally inhibited in a single apparatus.

60. The method of any one of claims 32 to 59 wherein the starch is dehydrated and thermally inhibited in different apparatuses.

61. The method of any of claims 32 to 60 wherein the thermally inhibited starch has a Hunter L value of greater than about 92, or greater than 92, or greater than 93, or greater than 94, or greater than 95, or about 92 to about 96 or about 92 to about 95, or about 93 to about 95, or about 94 to about 95, or about 95.

62. The method of any of claims 32 to 61 wherein the method improves the whiteness value of a thermally inhibited starch by a Hunter L value of at least about 2 or at least about 3 compared to a test thermally inhibited starch made at pH of about neutral or greater.

63. The method of any of claims 32 to 62 wherein the method improves the whiteness value of an unwashed thermally inhibited starch by a Hunter L value of at least about 3, or at least, about 4, or at least about 5 compared to a test thermally inhibited starch at a pH of about neutral or greater.

64. The method of a starch as described in any of the thirty-second to sixty-third aspects wherein during step (i) the starch is soaked in an acidic slurry for from about 0.5 to about 24 hours.

65. A method of preparing a thermally inhibited starch comprising the steps of: a) obtaining a starch slurry; (b) optionally pH adjusting a pH of the starch slurry to obtain a starch having a pH substantially equivalent to the natural pH of starch; (c) adding a buffering agent to the starch slurry and soaking for more than a few minutes to obtain a buffered starch, (d) adjusting the pH of the slurry to from more than about 4.0 to less than about 6.0 for and soaking the starch in slurry and if necessary continuing to adjust the pH of the slurry until the slurry's pH stabilizes from more than about 4.0 to less than about 6.0 to obtain a pH adjusted starch; (e) dehydrating the pH adjusted starch to obtain; and (f) thermally inhibiting the dried starch to obtain a thermally inhibited starch.

66. The method of claim 65 wherein the in step (b) the starch is adjusted to a pH of from about 5.5 to about 6.5, by optionally soaking the starch in a pH adjusted slurry for from about 0.25 to about 24 hours, or from about 0.3 hours to about 12 hours or from about 0.5 to about 8 hours, and wherein the starch slurry is optionally pH adjusted by the addition of a base or an acid.

67. The method of either claim 65 or 66 further comprising prior to step (a) obtaining a starch having a pH of less than about 5 and the pH adjustment of step (b) is accomplished by adding a base to the starch slurry, and wherein the base is optionally sodium hydroxide.

68 The method of any one of claims 65 to 67 wherein the starch is soaked in step (b) for from 0.25 to about 24 hours, or from about 0.3 hours to about 12 hours or from about 0.5 to about 8 hours.

69. The method of any one of 65 to 68 wherein step (d) adjusts the pH of the slurry to a lower pH, optionally using hydrochloric acid.

70. The method of any one of claims 65 to 69 wherein the starch is soaked in step (d) for from about 0.25 to about 24 hours, or from about 0.3 hours to about 12 hours or from about 0.5 to about 8 hours.

71. The method of any one of claims 65 to 70 wherein the buffer is either a citrate buffer or a carbonate buffer.

72. The method of any one of claims 65 to 71 wherein in step (d) the starch is adjusted to a pH of more than about 4 to about 5.5 or to more than about 4 to about 5.4, or to more than about 4 to about 5.3, or to more than about 4 to about 5.2, or to more than about 4 to about 5.1 or to more than about 4 to about 5, or to more than about 4 to about 4.9, or to more than about 4 to about 4.8, or to more than about 4 to about 4.7 or to more than about 4 to about 4.6, or to more than about 4 to about 4.5, or about 4.1 to about 4.6, or about 4.2 to about 4.7, or about 4.3 to about 4.8, or about 4.5 to about 5.5, or about 4.4 to about 5.5, or about 4.3 to about 5.5, or about 4.2 to about 5.5 or about 4.1 to about 5.5, or about 4.6 to about 5.4, or about 4.8 to about 5.3, or from about 4.8 to about 5.2.

73. The method of any one of claims 65 to 72 wherein in step (e) the starch is dehydrated to a moisture content of about 5% or less than about 4%, or less than about 3% or less than about 2% or less than about 1% or about 0% moisture content by weight of the starch, or to about 0% to about 6% or to about 0% to about 3%, or about 0% to about 2%, or to about 1% to about 5%, or to about 1% to about 4%, or to about 1% and about 3%, or to about 1% to 2% or to about 1%, or to about 0%.

74. The method of any one of claims 65 to 73 wherein in step (e) starch is dehydrated at a temperature below the starch's gelatinization temperature.

75. The method of any one of claims 65 to 74 wherein the starch is heated in step (f) to a temperature above the starch's gelatinization for about 0.05 to about 4 hours, or about 0.1 to about 4 hours, or about 0.2 to about 4 hours, or about 0.2 to about 3 hours, or to about 0.2 to about 2 hours, or about 0.2 to about 1.5 hours, or about 0.25 to about 1.5 hours, or about 0.3 to about 1.5 hours, or about 0.35 to about 1.5 hours, or about 0.4 to about 1.5 hours, or about 0.45 to about 1.5 hours, or about 0.5 to about 1.5 hours, or about 0.5 to about 1 hour, or about 0.5 to about 0.9 hours, or about 0.5 to about 0.8 hours, or about 0.5 to about 0.7 hours, or about 0.5 to about 0.6 hours, about 0.1 hours, or about 0.2 hours, or about 0.3 hours, or about 0.4 hours or about 0.5 hours, or about 0.6 hours, or about 0.7 hours, or about 0.8 hours, or about 0.9 hours, or about 1 hour.

76. The method of any one of claims 65 to 75 wherein the starch is thermally inhibited in step (f) at a temperature of from about 120° C. to about 200° C., or about 120° C. to about 190° C., or about 120° C. to about 180° C., or about 130° C. to about 170° C., or about 135° C. to about 165° C., or about 140° C. to about 165° C., or about 145° C. to about 165° C., or about 150° C. to about 165° C., or about 155° C. to about 165° C. In any embodiment a starch is heated to a temperature about 155° C. to about 165° C.

77. The method of any one of claims 65 to 76 wherein the starch is thermally inhibited in step (f) at a temperature of 150° C. to 170° C. for 20 to 40 minutes, or at a temperature of 160° C. to 180° C. for 30 to 50 minutes, or at a temperature of 160° C. to 180° C. for 45 and 60 minutes.

78. The method of any one of claims 65 to 77 wherein the pH adjusted starch is dehydrated and thermally inhibited in a dry process, and optionally in air or vacuum.

79. The method of any one of claims 65 to 78 wherein the thermally inhibited starch substantially alcohol free, and optionally is substantially alcohol free at each step from steps (a) through (f).

80. The method of any one of claims 65 to 79 further comprising washing the starch prior to step (a) or after step (f) or both.

81. The method of any one of claims 65 to 80 wherein the method is carried out in one of a batch process, a continuous-like process, a continuous process and combinations thereof.

82. The method of any one claims 65 to 81 wherein the pH adjusted starch is thermally inhibited in a fluid bed reactor or mechanical mixer.

83. The method of any one of claims 65 to 82 wherein the pH adjusted starch is thermally inhibited in a continuous process, and optionally in a VOMM reactor, and optionally for from about 10 to about 25 minutes.

84. The method of any one of claims 65 to 83 wherein the starch is dehydrated and thermally inhibited in one or more apparatuses.

85. The method of any one claims 65 to 84 wherein the starch obtained has a Hunter L value of greater than about 92, or greater than 92, or greater than 93, or greater than 94, or greater than 95, or about 92 to about 96 or about 92 to about 95, or about 93 to about 95, or about 94 to about 95, or about 95.

86. The method of any one of claims 65 to 85 wherein the starch obtained has a whiteness value of a thermally inhibited starch by a Hunter L value of at least about 2 or at least about 3 compared to a test thermally inhibited starch made at pH of about neutral or greater.

87. The method of any one of claims 65 to 86 wherein the starch obtained as a whiteness value of an unwashed thermally inhibited starch by a Hunter L value of at least about 3, or at least about 4, or at least about 5 compared to a test thermally inhibited starch at a pH of about neutral or greater.

88. The method of any of claims 65 to 87 wherein the protein level of the starch is less than about 1% (w/w) or is less than about 0.5% or, is less than about 0.3%.

89. The method of any one of claims 65 to 88 wherein the thermally inhibited has a soluble starch content of less than about 20%, or less about 15%, or less than about 10%, or less than about 5% or essentially 0%.

90. The method of any one claims 65 to 89 wherein the starch obtained from the method has a peak hot viscosity up to about 2000 MVU, or about 50 and about 2000 MVU, or less than about 500 MVU, or about 50 to about 500, or about 100 to about 500 MVU, or about 100 to about 400 MVU, or about 100 to about 300 MVU, or about 100 to about 200 MVU, or about 500 to about 1200 MVU, or about 600 to about 1200 MVU, or about 700 to about 1200 MVU, or about 800 to about 1200 MVU, or about 900 to about 1200 MVU, or about 1000 to about 1200 MVU, or about 1200 to about 2000 MVU, or about 1300 to about 2000 MVU, or about 1400 to about 2000 MVU, or about 1500 to about 2000 MVU, or about 1600 to about 2000 MVU, or about 1700 to about 2000 MVU, or about 1800 to about 2000 MVU.

91. A starch made according to any of the process of any one of claims 32 to 90.

92. Use of the starch of the ninety-first aspect in a groups consisting of industrial products, cosmetic products, household product, and edible product.

93. A composition comprising the starch of the ninety-first aspect and a second ingredient.

The recitation of various embodiments and aspects of the technology illustrative and not limiting. Other embodiments and aspects of the technology that are not specifically recited in this specification would be within the skill of one of ordinary skill in the art, and as such are encompassed by the scope of the claims either literally or by equivalence at least by reason of the following.

Use of “about” to modify a number is meant to include the number recited plus or minus 10%. Where legally permissible recitation of a value in a claim means about the value. Use of about in a claim or in the specification is not intended to limit the full scope of covered equivalents.

Use of “about neutral pH” is meant to include a pH range of about 6.5 to about 7.5.

Recitation of the indefinite article “a” or the definite article “the” is meant to mean one or more unless the context clearly dictates otherwise.

While certain embodiments have been illustrated and described, a person with ordinary skill in the art, after reading the foregoing specification, can effect changes, substitutions of equivalents and other types of alterations to the methods, and the starch of the present technology including uses of such starch in food composition, nutraceutical compositions, or pharmaceutical compositions industrial composition, household compositions, and cosmetic composition. Each aspect and embodiment described above can also have included or incorporated therewith such variations or aspects as disclosed regarding any or all the other aspects and embodiments.

The present technology is also not to be limited in terms of the aspects described herein, which are intended as single illustrations of individual aspects of the present technology. Many modifications and variations of this present technology can be made without departing from its spirit and scope, as will be apparent to those skilled in the art. Functionally equivalent methods within the scope of the present technology, in addition to those enumerated herein, will be apparent to those skilled in the art from the foregoing descriptions. Such modifications and variations are intended to fall within the scope of the appended claims. It is to be understood that this present technology is not limited to methods, conjugates, reagents, compounds, compositions, labeled compounds or biological systems, which can, of course, vary. All methods described herein can be performed in any suitable order unless otherwise indicated herein or otherwise clearly contradicted by context. It is also to be understood that the terminology used herein is for the purpose of describing aspects only and is not intended to be limiting. Thus, it is intended that the specification be considered as exemplary only with the breadth, scope and spirit of the present technology indicated only by the appended claims, definitions therein and any equivalents thereof. No language in the specification should be construed as indicating any non-claimed element as essential.

The embodiments illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

In addition, where features or aspects of the disclosure are described in terms of Markush groups, those skilled in the art will recognize that the disclosure is also thereby described in terms of any individual member or subgroup of members of the Markush group. Each of the narrower species and subgeneric groupings falling within the generic disclosure also form part of the technology. This includes the generic description of the technology with a proviso or negative limitation removing any subject matter from the genus, regardless of whether the excised material is specifically recited herein.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member, and each separate value is incorporated into the specification as if it were individually recited herein.

All publications, patent applications, issued patents, and other documents (for example, journals, articles and/or textbooks) referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims, along with the full scope of equivalents to which such claims are entitled.

### Procedures and Results

### Swelling Volume and Soluble Content of Thermally Inhibited Starch

Prepare a 5% starch slurry in 1% NaCl solution in a beaker. 2. Cook in a boiling water bath (minimum temperature of 95° C.) for 20 minutes (stir for the first 3 minutes and then cover with a watch glass for the remaining time). 3. Dilute the solution to 1% in a graduated cylinder and allow it to settle for 24 hrs (72 hrs is required for the waxy rice starch, as its smaller particle size slows settling). 4. Record the volume of the settled sample in milliliters. 5. Extract an aliquot of the supernatant from the cylinder. 6. Using a hand-held refractometer or a polarimeter, measure the concentration of starch in the supernatant and calculate the % solubles.

### Whiteness and Visocity Testing

The effect of pH on thermally inhibition time was evaluated as follows. With reference to FIG. 1a applicants measured the MVU viscosity of thermally inhibited waxy corn starch made using a citrate buffer and pH adjusted to about 5. Starch was dehydrated to about 1% moisture (w/w) and was heated at 310° F. (about 154° C.) for the times shown. The MVU profile was obtained for starch slurry having 6% solids (w/w) and pH 6, using the following heating profile: heat from 45° C. to 95° C. degrees over six minutes and then was held at 95° C. for another 6 minutes. With reference two FIG. 1b the viscosity of each sample at 95° plus 6 minutes was plotted, illustrating the amount of inhibition varies with heating time. The foregoing test was repeated using starch made as described above but heated at 320° F. or 330° F. (about 160° C. to about 165° C.). The same plots as described above were obtained to illustrate how inhibition varies with heating time and temperature. To illustrate the effect buffer system and pH adjustment, the waxy corn starch was inhibited at the times and temperatures described above, but starch that was carbonate buffered and adjusted to pH of about 8 or was citrate buffered and adjusted to pH of about 7. The full set of 95° C.+6 minutes viscosity is plotted in FIG. 1c.

FIG. 2 plots the Hunter L value of the above starches. To determine the color of powder, Hunter Color QUEST II spectrocolorimeter sphere model was used with Universal V.36 software and a NIR compression cell with quartz window. The equipment is standardized using a light trap, white and grey standardization tiles and a green calibration tile. First the light trap is inserted into the sample hold, then removed and followed by the white and grey tiles. Using the XYZ units, the white and green tiles are used to calibrate the equipment. Once the equipment is calibrated, the units are changed to hunter units. Using the quartz cell, approximately 4 grams of starch is added into the cell until the window is covered and the cell is packed. Place the cover on the cell and place the cell in the sample holder of the spectrocolorimeter. Using the software, select read sample to acquire data. The data collected will be in the form of L, a, b, and YI D1925 (2/C).

The viscosity change of a 6% solids starch slurry, was measured over the following time course: of starches made using a citrate buffer and adjusted to pH 5 heated as follows of starch slurry from room temperature to 50° C., further heating of slurry from 50° C. to 95° C. at a heating rate of 8° C./min, and holding slurry at 95° C. for 15 minutes. The starches were heated to obtain a desired viscosity profile consistent with commercially available lowly, moderately and highly inhibited starch. FIG. 3 illustrates the viscosity profile of a lowly inhibited starch in pH 6 slurry. FIG. 4 illustrates the viscosity profile of a moderately inhibited starch in pH 3 slurry. FIG. 5 illustrates the viscosity profile of a highly inhibited starch in pH 3 slurry.

The effect of time, temperature and pH on thermally inhibition was evaluated. In all samples a waxy corn starch was thermally. Samples were made using citrate buffer and adjustment to pH of about 5, using citrate buffer and adjustment to pH of about 7, and carbonate buffer and adjustment to pH about 8. Thermally inhibited using the above described buffer systems were dehydrated to about 1% moisture (w/w). Starch samples from each buffer system were then thermally inhibited one of 310° F., 320° F., or 330° F. (about 154° C., 160° C., or 165° C. Samples made at each thermally inhibition temperature were heated for one of 0 (uninhibited), 20, 40, 60, 80, 100, 120, 140, 160, and 180 minutes. All samples were tested whiteness recorded as a Hunter L value. Changes in Hunter L as inhibition time increases for a given buffer system and inhibition temperature are reported in FIG. 2.

### Sensory Testing of Dry Thermally Inhibited Starch

Sensory testing compared flavor of starch pastes (starch in water heating until gelatinization). Panelists evaluated pastes made from embodiments of the disclosed dry thermally inhibited starches made from waxy corn starch, commercially available thermally inhibited starches waxy corn starch from an alcohol-based process, commercially available dry thermally inhibited waxy corn starch, and unmodified waxy corn starch. All thermally inhibited samples were measured to have a peak hot viscosity of about 800 MVU.

Sensory testing was done using a trained panel of 10 people. Panelists were selected based on their ability to detect differences in aroma, flavor, taste and texture and their ability to express these differences. Individual panelists were trained for 4 months prior to panel integration, and all panelist participated in continuous maintenance training. Training comprises introducing panelists to company defined sensory terminology (TEXICON® and SWEETABULARY®) and 15-point universal scale ratings benchmarks with 0 meaning a flavor attribute was not detected, and 15 meaning that a flavor attribute was extreme.

Testing proceeded as follows: Panelists were presented three replicates of each sample in monadic and balanced order. During evaluation panelists were instructed to take a spoonful of the sample by mouth manipulate the sample to the point of swallowing, expectorate the sample swallow the saliva, and Evaluate the perceived intensity of the following flavors. Panelists evaluated samples as for the following attributes: i) Overall Flavor Intensity-meaning the impact of the total flavor of the sample; ii) Overall Source Flavor Intensity-meaning the perceived intensity of the flavor contributed by the raw material; iii) White Paper Flavor Intensity—meaning the perceived intensity of the flavor contributed by white paper; iv) Cardboard Flavor Intensity—meaning the perceived intensity of the flavor contributed by brown paper/cardboard; v) Overall Chemical Flavor Intensity (solvent, plastic/vinyl, chlorine, etc.)—meaning the perceived intensity of the flavor contributed by any chemical substance. Panelists were also asked to describe the chemical flavor tasted.

Ratings were collected through Compusense® Cloud data acquisition software and data were analyzed for statistical significance and statistical relevance use XLSTAT (2016) data analysis software.

Samples were prepared by Ingredion's Global Applications Team. Samples were stored and served at 40° F. in 4-ounce plastic cups with lids.

Results were reported in a Principal Component Analysis (“PCA”) mapped in a Sensory Space. PCA investigates and plots a multi-dimensional dataset comprising quantitative variables. The Sensory Space allows, for study and visualization of the correlations between variables. It allows for obtaining non-correlated factors which are linear combinations of the initial variables to use these factors in modeling methods such as linear regression, logistic regression or discriminant analysis, and for visualizing observations in a multidimensional space to identify uniform or atypical groups of observations.

The plotted Sensory Space maps the relative intensity of a flavor observed for a sample. Flavor characteristics are placed along the perimeter of the plot. The closer a sample is to the characteristic the more intensely that flavor characteristic was observed for that sample. As seen prior art dry thermally inhibited waxy corn starch had the most intense cardboard and grain flavor.

### Hexanal Analysis

Hexanal formation was measured using a homogenous (relative to granule size) flour sample mixed with water containing a defined standard for measuring hexanal. This mixture was heated in a heating block for a specified amount of time, after which time a sample of the headspace over the mixture was taken and injected into a gas chromatograph coupled with flame ionization detection (FID). Hexanal released into the headspace was quantified by comparison of the hexanal gas's chromatographic response to that of the defined standard. Hexanal levels were obtained from thermally inhibited flours stored at room temperature after 0, 2 and 4 weeks.

Three hundred (300) gram samples each of waxy rice grain, waxy rice flour, whole waxy corn grain and waxy corn flour were heat treated at various temperatures for various lengths of time. The sample grains and flours were dehydrated to substantially anhydrous and heat treated in a lab oven. The samples were loaded into the oven and brought from ambient temperature to 100° C. until the samples became at least substantially anhydrous, and were then further heated to the specified heat treating temperatures (e.g., 130° C. or 140° C.), with the temperature ramped up over a time of about 5 to 15 minutes, and held at those heat treating temperatures for a specified amount of time.

The waxy corn grain and waxy corn flour were not pH-adjusted. The waxy rice grain and waxy rice flour were pH adjusted as follows. For the grain, a 1:3 mixture of grain to 1.2% potassium citrate solution, and was preheated in water bath at 50° C. The grain was allowed to steep in the buffer for 24 hours. After 24 hours, the beaker was removed from the bath and the steep solution drained. The grain was then placed on a tray and dried in an oven at 50° C. overnight to a moisture content of less than 12%, based on total weight of the grain. For the flour, it was sprayed with the 1.2% potassium citrate solution in the same amount as remaining in the steeped grain, and then dried in an oven at 50° C. overnight to a moisture content of less than 12%, based on total weight of the flour. The dried grain and flour were then heat treated as described above for the waxy corn grain and waxy corn flour.

Processing conditions and storage stability are set forth in Table 3 below.

TABLE 1
Sample Processing Conditions and Resulting Stability

| | Process Variables | | | Hexanal (ppm) | | |
|---|---|---|---|---|---|---|
| | | Temperature | Time | 0 week | 2 weeks | 4 weeks |
| Sample | pH | (° C.) | (min) | storage | storage | storage |
| WC ¹ | — | — | — | 1.5 | 1.5 | 1.8 |
| Flour | | | | | | |
| WC | — | 130 | 60 | 3.6 | 3.5 | 2.9 |
| Flour-1 | | | | | | |
| WC | — | 130 | 60 | 1.1 | 1.0 | 1.0 |
| Grain-1 | | | | | | |
| WC | — | 140 | 30 | 3.2 | 3.0 | 2.8 |
| Flour-2 | | | | | | |
| WC | — | 140 | 60 | 1.0 | 0.9 | 0.8 |
| Grain-2 | | | | | | |
| WC | — | 140 | 60 | 6.8 | 7.0 | 5.1 |
| Flour-3 | | | | | | |
| WC | — | 140 | 120 | 1.0 | 1.0 | 0.9 |
| Grain-3 | | | | | | |
| WR | — | — | — | 3.6 | 2.9 | 2.6 |
| Flour | | | | | | |
| WR | 8.32 | 140 | 30 | 11.9 | 8.6 | 6.9 |
| Flour-1 | | | | | | |
| WR | 8.32 | 140 | 30 | 2.2 | 1.6 | 1.4 |
| Grain-1 | | | | | | |
| WR | 8.32 | 140 | 120 | 7.5 | 6.5 | 6.0 |
| Flour-2 | | | | | | |
| WR | 8.32 | 140 | 120 | 3.0 | 2.3 | 1.5 |
| Grain-2 | | | | | | |
| WR | 8.32 | 165 | 30 | 10.2 | 8.8 | 7.0 |
| Flour-2 | | | | | | |
| WR | 8.32 | 165 | 30 | 3.2 | 2.6 | 1.6 |
| Grain-2 | | | | | | |

¹ “WC” and “WR” are abbreviations for waxy corn and waxy rice. WC flour and WR flour are controls and were not thermally inhibited.

Samples were analyzed for rancidity by hexanal analysis, with the results provided in Table 1 above. It is seen that flour from thermally inhibited grain (both corn and rice) had a much reduced level of lipid oxidation compared to the thermally inhibited flours, at zero, two and four weeks. This illustrates that thermally inhibited grain flour had less hexanal, and so would be expected to be perceived to taste better than flour that was thermally inhibited after milling. It is also seen that the thermally inhibited grain flour had reduced hexanal levels at zero, two and four weeks than flour than the controls (i.e., non-thermally inhibited flours). This illustrates that thermally inhibited flours obtained from thermally inhibited grains have greater shelf life compared to flours that are thermally inhibited.

### Effect of Steeping on Thermal Inhibition

Nine samples of waxy rice grain (dehulled and debranned) were steeped in a buffer at various temperatures and then thermally inhibited for various amounts of time. The waxy rice grain samples were pH adjusted as follows. The waxy rice grain was pH-adjusted by adding 300 grams of the grain in a 1:3 mixture of grain to buffer to a 1.2% potassium citrate solution, and preheated in water bath at 50° C., 60° C. or 70° C. and covered. The grain was allowed to steep in the buffer for 24 hours. After 24 hours, the beaker was removed from the bath and the steep solution drained. The grain was then placed on a tray and dried in an oven at 50° C. overnight to a moisture content of less than 12% (w/w). The dried grain samples were then dehydrated (100° C.) to anhydrous or substantially anhydrous and then heat treated at the indicated temperature and for the indicated time.

TABLE 2
Steeping Prior to Thermal Inhibition

| | Process Variables | | | | |
|---|---|---|---|---|---|
| | Buffer | pH after | | | |
| | Temperature | 24 h | Moisture | Temperature | Time |
| Sample | (° C.)² | steeping | (%) | (° C.) | (min) |
| WR Grain ¹ | — | — | 12.33 | — | — |
| WR Grain-1 | 50 | 5.82 | 6.53 | — | — |
| WR Grain-2 | 60 | 5.82 | 7.07 | — | — |
| WR Grain-3 | 70 | 5.82 | 7.45 | — | — |
| WR Grain-4 | 50 | 5.82 | 4.50 | 140 | 60 |
| WR Grain-5 | 60 | 5.82 | 3.38 | 140 | 60 |
| WR Grain-6 | 70 | 5.82 | 3.89 | 140 | 60 |
| WR Grain-7 | 50 | 5.82 | 3.30 | 140 | 120 |
| WR Grain-8 | 60 | 5.82 | 3.47 | 140 | 120 |
| WR Grain-9 | 70 | 5.82 | 2.85 | 140 | 120 |

¹ Waxy rice (WR) Grain is a control and was not thermally inhibited or buffered.
² Other than the control, all grain samples were steeped in buffer (1.2% potassium citrate) for 24 hours at the temperatures listed above. WR Grain-1, WR Grain-2 and WR Grain-3 were buffered but not heat treated.

After buffering and inhibiting the grain samples, each sample was milled to pass through an 80 mesh sieve. Viscosities of the samples were determined according to the paste viscosity test procedure described above. The results are provided in Table 3 below.

TABLE 3
Paste Viscosities

| Sample | Peak Viscosity (MVU) | End Viscosity (MVU) |
|---|---|---|
| WR Grain | 286 | 146 |
| WR Grain-1¹ | — | — |
| WR Grain-2 | — | — |
| WR Grain-3 | — | — |
| WR Grain-4 | 219 | 219 |
| WR Grain-5 | 155 | 155 |
| WR Grain-6 | 238 | 238 |
| WR Grain-7 | 173 | 173 |
| WR Grain-8 | 102 | 102 |
| WR Grain-9 | 202 | 202 |

¹Viscosities of the flours from the buffered, non-thermally treated waxy rice grains were substantially the same as that for the control.

### Example 4—Color of Thermally Inhibited Flours

Color of waxy rice grain thermally inhibited (heating 2 h at 140° C.) and milled to obtain flour was compared to thermally inhibited waxy rice flour that was milled prior to inhibition. Color was measured using a colorimeter and in Table 4 is reported using L* value and Yellowness Index (YI).

TABLE 4
Color of Thermally Inhibited Flours

| Sample | L* | YI |
|---|---|---|
| Waxy rice flour sprayed with buffer, 2 h@140° C. | 88.0 | 25.0 |
| Waxy rice grain steeped with buffer, 2 h@140° C. | 92.2 | 12.7 |

As seen in Table 4, thermally inhibited flour obtained from thermally inhibited grain had higher L* value and lower yellowness index. Indicating the color is lighter (higher L* value) and less yellow.

We claim:

1. A method of preparing a thermally inhibited starch comprising the steps of:
(a) obtaining a starch slurry;
(b) if necessary, adjusting a pH of the starch slurry to obtain a starch having a pH of from 5.5 to 6.5;
(c) adding a buffering agent to the starch slurry and soaking for more than 0.25 hours to obtain a buffered starch,
(d) adjusting the pH of the starch slurry to a range from more than 4.0 to less than 5.5 for and soaking the buffered starch in the starch slurry and if necessary continuing to adjust the pH of the starch slurry until the starch slurry's pH stabilizes at a pH from more than 4.0 to less than 5.5 to obtain a pH adjusted starch;
(e) dehydrating the pH adjusted starch to obtain a dried starch; and
(f) thermally inhibiting the dried starch to obtain a thermally inhibited starch.

2. The method of claim 1 further comprising prior to step (a) of obtaining a starch having a pH of less than 5 and wherein the pH adjustment of step (b) is accomplished by adding a base to the starch slurry.

3. The method of claim 1 wherein the buffer is either a citrate buffer or a carbonate buffer.

4. The method of claim 1 wherein in step (e) the starch is dehydrated to a moisture content of 5%.

5. The method of claim 1 wherein the starch is heated in step (f) to a temperature above 120° C. for 0.05 to 4 hours.

6. The method of claim 1 wherein the starch is thermally inhibited in step (f) at a temperature of from 120° C. to 200° C.

7. The method of claim 1 wherein the starch is thermally inhibited in step (f) at a temperature of 150° C. to 170° C. for 20 to 40 minutes.

8. The method of claim 1 wherein the pH adjusted starch is dehydrated and thermally inhibited in a dry process, and optionally in air or vacuum.

9. The method of claim 1 wherein the thermally inhibited starch substantially alcohol free, and optionally is substantially alcohol free at each step from steps (a) through (f).

10. The method of claim 1 wherein the method is carried out in one of a batch process a continuous process and combinations thereof.

11. The method of claim 1 wherein the pH adjusted starch is thermally inhibited in a fluid bed reactor or mechanical mixer.

12. The method of claim 1 wherein the starch obtained has a Hunter L value of from 92 to 95.

13. The method of claim 1 wherein the thermally inhibited has a soluble starch content of less than 5%.

14. A thermally inhibited starch being thermally inhibited and dehydrated in a dry process and having a Hunter L value of greater than about 92.

15. The thermally inhibited starch of claim 14 having a hot peak viscosity (slurry at 6% solids and pH 6) of about 50 to about 500 MVU and a Hunter L value of at least about 91, or from about 91 to about 94.

16. The thermally inhibited starch of claim 14 having a hot peak viscosity (slurry at 6% solids, and pH 6) of about 500 to about 1200 MVU and having a Hunter L value of about 93 to about 95.

17. The thermally inhibited starch of claim 14 a hot peak viscosity (slurry at 6% solids, and pH 6) of about 1200 to about 2000 MVU and having a Hunter L value of about 94 to about 96.

18. The thermally inhibited starch of claim 14 wherein prior to thermal inhibition the milled and fractionated plant material has a starch content greater than 95% (w/w).

19. The thermally inhibited starch of claim 14 being substantially free of alcohol.

20. The thermally inhibited starch of claim 14 wherein the thermally inhibited has a soluble starch content of less than about 5% or essentially 0%.
